(19) United States
(12) Patent Application Publication
(10) Pub. No.: US 2013/0016708 A1
(43) Pub. Date: Jan. 17, 2013

(54) Wireless Network System, Method of Controlling the System, and Wireless Network Relay Device

(71) Applicant: Yoshifumi Haba, Nagoya-shi (JP)

(72) Inventor: Yoshifumi Haba, Nagoya-shi (JP)

(73) Assignee: BUFFALO INC., Nagoya-shi (JP)

(21) Appl. No.: 13/526,548

(22) Filed: Jun. 19, 2012

(30) Foreign Application Priority Data
Jul. 15, 2011 (JP) 2011-156281

(51) Int. Cl. H04W 92/04; H04W 16/00

(52) U.S. Cl. 370/338; 455/7

(57) ABSTRACT

A wireless network system includes first and second network relay devices, with the first relay device having first wireless communication setup information pre-set thereto and including a first communication I/F part and a first wireless communication setup information transmission part for sending first wireless communication setup information to the second wireless relay device if the first and second relay devices are enabled to communicate with each other, and with the second relay device including: a second communication I/F part; a first wireless communication setup information reception part for receiving the first wireless communication setup information via the second communication I/F part; and a first wireless communication part for performing wireless communication with a client by using the received first wireless communication setup information.

### BACKGROUND OF THE INVENTION

1. Technical Field

The present invention relates to configuring information used in wireless communications.

2. Description of the Related Art

Technology whereby a transmission control protocol (TCP)/internet protocol (IP) session is established between a wireless local area network (LAN) access point (also referred to simply as “access point” hereinafter) arranged in a home, office, etc., and an access point arranged in a site away from the home or similar location, to continue communications in the event the wireless LAN environment of a personal computer or other wireless LAN client device (also referred to simply as “client” hereinafter) changes has been proposed. (Reference is made to Japanese Unexamined Patent App. Pub. No. 2009-284114.)

The above-described technology for establishing a TCP/IP session between an access point in a home or similar location, and an access point in a site away from the home or similar location, is premised on the access points being fixed in the respective locations.

Mobile (portable) access points have of late been proposed as access points enabling connection from a client to the Internet or other network via the mobile access point, in locations where no stationary access point has been installed.

In situations in which a router device having a wireless communications function (for example, a home gateway—termed a “wireless router” hereinafter—provided, e.g., by an Internet service provider (ISP)) is used in a home or similar location, and in situations in which a mobile access point is used in a site away from a home or similar location to, in either case, connect to the Internet or another network, connecting a client at the home or similar location to the Internet or an other network via the wireless router lets higher-speed communications be realized. This is because in general, the communications band on the access line from the wireless router to the Internet (e.g., an optical line or an asymmetric digital subscriber line (ADSL)) is broader than on the access line from the mobile access point to the Internet (e.g., a third generation (3G)/high speed packet access (HSPA) line).

Mobile access points and wireless routers, however, differ from each other in terms of various types of configurational information used in wireless communications (service set identifier (SSID), security class, security key, and similar information—termed “wireless communications setup information” hereinafter). A consequent problem has been that a client on the move from an outside destination to a home or similar location cannot connect wirelessly to a router device configured as it is. For similar reasons, a problem for a client having been connected to the Internet or other network via a wireless router at a home or similar location has been not being able, in a site away from the home or similar location, to wirelessly connect to a mobile access point configured as it is.

It will be appreciated that the above-described problems are not limited to mobile access points, and may occur when a fixed access point or any given similar wireless network relay device is moved. Furthermore, these problems are not limited to wireless routers, and may occur in situations where a Layer-3 switch or any given similar wireless network relay device having a wireless communications function is set up (i.e., stationarily disposed).

### BRIEF SUMMARY OF THE INVENTION

An object of the present invention is to resolve at least part of the issues discussed above.

A wireless network system according to the present invention is the system that includes a first wireless network relay device and a second wireless network relay device. Further, the first wireless network relay device to which first wireless communication setup information used for performing wireless communication with a client is set includes: a first communication interface unit for communicating with the second wireless network relay device; and a first wireless communication setup information transmission unit for sending the first wireless communication setup information to the second wireless network relay device if the first wireless network relay device and the second wireless network relay device are enabled to communicate with each other via the first communication interface unit. Further, the second wireless network relay device includes: a second communication interface unit for communicating with the first wireless network relay device via the first communication interface unit; a first wireless communication setup information reception unit for receiving the first wireless communication setup information via the second communication interface unit; and a first wireless communication unit for performing wireless communication with the client by using the first wireless communication setup information received via the second communication interface unit.

With the configuration described above, the first wireless communication setup information that is pre-set to the first wireless network relay device is sent to the second wireless network relay device, and wireless communication is performed at the second wireless network relay device using the first wireless communication setup information if the first wireless network relay device and the second wireless network relay device are enabled to communicate with each other. Therefore, a client enabled to perform wireless communication using the first wireless communication setup information can be wirelessly connected to the first wireless network relay device at a location where the second wireless network relay device is not placed, and can be wirelessly connected to the second wireless network relay device at a location where it is placed. In addition, the first wireless communication setup information is automatically sent to the second wireless network relay device and is used for wireless communication. It is therefore possible to reduce a work load imposed on the user who otherwise confirms the content of the first wireless communication setup information on the first wireless network relay device and sets the content to the second wireless network relay device. Further, with this configuration, the second wireless network relay device requires no provision of input means for the user to set the first wireless communication setup information thereto or of display means for displaying an input result thereon, thereby minimizing production cost of the second wireless network relay device.

In the wireless network system according to the present invention, the first wireless communication setup information transmission unit sends the first wireless communication setup information to the second wireless network relay device when receiving therefrom a request for transmission of the first wireless communication setup information, and the second wireless network relay device further includes a request transmission unit for sending the request for transmission to the first wireless network relay device if the first wireless network relay device is enabled to communicate with the second wireless network relay device via the second communication interface unit.

The configuration described above makes it possible to send the first wireless communication setup information to the second wireless network relay device after determining whether an inter-device distance allows communication with each other, accomplishing the exchange of the first wireless communication setup information only when the inter-device distance allows communication with each other. Therefore, if the inter-device distance allows no communication, it is possible to curtail exchange of the first wireless communication setup information. Further, the second wireless network relay device determines whether an inter-device distance allows communication with each other, making it possible to reduce a processing load at the first wireless network relay device.

In the wireless network system according to the present invention, the second wireless network relay device further includes: a storage unit for pre-storing therein second wireless communication setup information; and an addition storage control unit for storing the received first wireless communication setup information additionally to the second wireless communication setup information in the storage unit, and the first wireless communication unit performs wireless communication with the client by using the first wireless communication setup information pre-stored in the storage unit and performs wireless communication with another client different from the client by using the second wireless communication setup information pre-stored in the storage unit.

The configuration described above makes it possible to store the second wireless communication setup information in the storage unit of the second wireless network relay device regardless of whether the device is enabled for communication. Therefore, it is possible to enable a client to be continuously wirelessly connected to the second wireless network relay device even when the device comes within a distance enabling communication, the client that has been wirelessly connected to the second wireless network relay device when the device had not been at such a distance.

In the wireless network system according to the present invention, the second wireless network relay device further includes: a storage unit for pre-storing therein the second wireless communication setup information; and an overwrite/storage control unit for overwriting the second wireless communication setup information with the received first wireless communication setup information to store the overwritten information therein, and the first wireless communication unit performs wireless communication with the client by using the first wireless communication setup information stored in the storage unit.

The configuration described above enables the second wireless network relay device to overwrite the second wireless communication setup information with the first wireless communication setup information received from the first wireless network relay device and stores the overwritten information in the storage unit, making it possible to reduce memory space in the storage unit, and minimize production cost of the second wireless network relay device.

In the wireless network system according to the present invention, at least one of the first and second wireless network relay devices includes an overwrite/storage instruction inputting user interface for inputting an instruction to overwrite the second wireless communication setup information with the first wireless communication setup information to store the overwritten information in the storage unit.

The configuration described above makes it possible to restrain an event in which the second wireless communication setup information is overwritten with the first wireless communication setup information without the user knowing the event.

In the wireless network system according to the present invention, the first communication interface unit and the second communication interface unit are enabled for communication by a physical contact to each other.

The configuration described above makes it easy to determine whether the devices are enabled for communication with each other by determining whether the first and second wireless network relay device have been brought into physical contact with each other.

In the wireless network system according to the present invention, the first wireless network relay device further includes: a second wireless communication unit for performing wireless communication with the client; and a wireless communication control unit for controlling the second wireless communication part. Further, the wireless communication control unit stops an operation of the second wireless communication unit in response to sending of the first wireless communication setup information.

The configuration described above makes it possible to suppress generation of noise interference and radio wave interference between the first and second wireless network relay devices. It is also possible to prevent a situation in which the client would not know which wireless network relay device is to be connected to at a location where the first and second wireless network relay devices are both placed, resulting in being unable to connect to another network.

In the wireless network system according to the present invention, the first wireless network relay device further includes a distance determination unit for determining whether an inter-device distance between the first and second wireless network relay devices is a predefined value, and the first wireless communication setup information transmission unit sends the first wireless communication setup information to the second wireless network relay device if the inter-device distance is a predefined value.

The configuration described above makes it possible to send the first wireless communication setup information to the second wireless network relay device after determining whether the inter-device distance is a predefined value, accomplishing the exchange of the first wireless communication setup information only when the inter-device distance is at the predefined value. Therefore, it is possible to curtail exchange of the first wireless communication setup information when the inter-device distance is not at the predefined value.

In the wireless network system according to the present invention, the second wireless network relay device further includes a distance determination unit for determining whether an inter-device distance between the first and second wireless network relay devices is a predefined value, and the request transmission unit sends the request for transmission to the first wireless network relay device if the inter-device distance is a predefined value.

The configuration described above makes it possible to send the first wireless communication setup information to the second wireless network relay device after determining whether the inter-device is a predefined distance, accomplishing the exchange of the first wireless communication setup information only when the inter-device is at the predefined distance. Therefore, it is possible to curtail exchange of the first wireless communication setup information when the inter-device is not at the predefined distance. Further, the second wireless network relay device determines whether the inter-device is at the predefined distance, thereby making it possible to reduce processing load at the first wireless network relay device.

In the wireless network system according to the present invention, the wireless communication setup information includes any of a Service Set Identifier (SSID), security class information and a security key.

The configuration described above makes it possible to automatically send information such as the SSID, security class information and security key to the second wireless network relay device from the first wireless network relay device, the information that has comparatively large amount and is relatively difficult for the user to remember. It is therefore possible to substantially reduce workload imposed on the user.

In the wireless network system according to the present invention, the first wireless network relay device is a portable wireless local area network (LAN) access point, and the second wireless network relay device is a stationary router device.

The configuration described above enables a client to be wirelessly connected to a portable wireless LAN access point if it is moved together with the client from a location where a stationary router device is placed to a location where no stationary router device is placed. Further, the configuration enables a client to be wirelessly connected to a stationary router device if a portable wireless LAN access point together with the client is returned to a location where the stationary router device is placed from a location where it is not placed.

A wireless network relay device according to the present invention is the device to which wireless communication setup information is pre-set, the information used for wireless communication with a client. Further, the device includes: a communication interface unit for communicating with another wireless network relay device; and a wireless communication setup information transmission unit for sending the wireless communication setup information to the other wireless network relay device if the wireless network relay device and the other wireless network relay device are enabled to communicate with each other.

The configuration described above makes it possible to send the pre-stored wireless communication setup information to another wireless network relay device if the wireless network relay device and the other wireless network relay device are enabled to communicate with each other, enabling the other wireless network relay device to perform wireless communication with the client using the received wireless communication setup information. Therefore, the client enabled to perform wireless communication using the wireless communication setup information is enabled to wirelessly connect to the wireless network relay device at a location where the other wireless network relay device is not placed, and to the other wireless network relay device at a location where it is placed. In addition, if the devices are enabled to perform communication with each other, the wireless communication setup information is automatically sent to the other wireless network relay device and is used for wireless communication. It is therefore possible to reduce a work load imposed on the user who otherwise confirms the content of the wireless communication setup information on the wireless network relay device and sets the content to the other wireless network relay device. Further, with this configuration, the other wireless network relay device requires no provision of input means for the user to set the wireless communication setup information thereto or of display means for displaying an input result thereon, thereby minimizing production cost of the other wireless network relay device.

In the wireless network relay device according to the present invention, the wireless communication setup information transmission unit sends the wireless communication setup information to the other wireless network relay device when receiving from the other wireless network relay device a request for transmission of the wireless communication setup information.

With the configuration described above, the pre-set wireless communication setup information is sent to the other wireless network relay device when the request for transmission is received therefrom, and thereby the other wireless network relay device is enabled to accomplish wireless communication with the client using the received wireless communication setup information. Therefore, the client enabled to perform wireless communication using the wireless communication setup information can be wirelessly connected to the wireless network relay device at a location where the other wireless network relay device is not placed, and to the other wireless network relay device at a location where it is placed. In addition, when a request for transmission is received from the other wireless network relay device, the wireless communication setup information is automatically sent to the other wireless network relay device and is used for the wireless communication, and it is therefore possible to reduce workload imposed on the user who otherwise confirms the content of the wireless communication setup information on the wireless network relay device and sets the content to the other wireless network relay device. Further, with this configuration, the other wireless network relay device requires no provision of input means for the user to set the wireless communication setup information thereto or of display means for displaying an input result thereon, thereby suppressing a production cost of the other wireless network relay device.

A wireless network relay device according to the present invention is the device including: a communication interface unit for communicating with another wireless network relay device to which wireless communication setup information used for wireless communication with a client is pre-set; a wireless communication setup information reception unit for receiving the wireless communication setup information via the communication interface unit; and a wireless communication unit for performing wireless communication with the client by using the wireless communication setup information received from the other wireless network relay device via the communication interface unit.

With the configuration described above, the wireless communication setup information that is set to the other wireless network relay device is received therefrom, and the wireless communication is performed by using the received wireless communication setup information. Therefore, the client enabled to perform the wireless communication using the wireless communication setup information is enabled to wirelessly connect to the other wireless network relay device at a location where the wireless network relay device is not placed, and to the wireless network relay device at a location where it is placed. In addition, the wireless communication is performed by using the wireless communication setup information received from the other wireless network relay device, and it is therefore possible to reduce workload imposed on the user who otherwise confirms the content of the wireless communication setup information on the other wireless network relay device and sets the content to the wireless network relay device. Further, with this configuration, the wireless network relay device requires no provision of input means for the user to set the wireless communication setup information thereto or of display means for displaying an input result thereon, thereby minimizing production cost of the wireless network relay device.

The wireless network relay device according to the present invention further includes a request transmission unit for sending the other wireless network relay device a request for transmission of the wireless communication setup information if the other wireless network relay device and the wireless network relay device are enabled to communicate with each other.

With the configuration described above, the wireless network relay device determines whether the devices are enabled to communicate with each other, making it possible to reduce a processing load of the other wireless network relay device.

A control method for a wireless network system according to the present invention is the control method for the system including a second wireless network relay device and a first wireless network relay device to which first wireless communication setup information used for performing wireless communication with a client is set, the method including: (a) a step of the first wireless network relay device sending the first wireless communication setup information to the second wireless network relay device if the first wireless network relay device and the second wireless network relay device are enabled to communicate with each other; and (b) a step of the second wireless network relay device performing wireless communication with the client by using the wireless communication setup information received from the first wireless network relay device.

With the configuration described above, the first wireless communication setup information that is pre-set to the first wireless network relay device is sent to the second wireless network relay device, and wireless communication is performed thereon by using the first wireless communication setup information if the first wireless network relay device and the second wireless network relay device are enabled to communicate with each other. Therefore, the client enabled to perform wireless communication using the first wireless communication setup information is allowed to wirelessly connect to the first wireless network relay device at a location where the second wireless network relay device is not placed, and to the second wireless network relay device at a location where it is placed. In addition, the first wireless communication setup information is automatically sent to the second wireless network relay device and is used for the wireless communication, and it is therefore possible to reduce a work load imposed on the user who otherwise confirms the content of the first wireless communication setup information on the first wireless network relay device and sets the content to the second wireless network relay device. Further, with this configuration, the second wireless network relay device requires no provision of input means for the user to set the wireless communication setup information thereto or of display means for displaying an input result thereon, thereby suppressing a production cost of the second wireless network relay device.

A recording medium according to the present invention is a recording medium non-volatilely recording therein a program for controlling a wireless network relay device to which wireless communication setup information used for performing wireless communication with a client is set, the program causing the wireless network relay device to carry out the functions of: determining whether the wireless network relay device and another wireless network relay device are enabled to communicate with each other via a communication interface; and sending the wireless communication setup information to the other wireless network relay device if the wireless network relay device and the other wireless network relay device are enabled to communicate with each other.

With the configuration described above, if the wireless network relay device and the other wireless network relay device are enabled to communicate with each other, the pre-set wireless communication setup information is sent to the other wireless network relay device, and therefore the other wireless network relay device is allowed to perform wireless communication with the client that uses the received wireless communication setup information. Therefore, the client enabled to perform wireless communication using the first wireless communication setup information is enabled to wirelessly connect to the wireless network relay device at a location where the other wireless network relay device is not placed, and to the other wireless network relay device at a location where it is placed. In addition, the wireless communication setup information is automatically sent to the other wireless network relay device and is used for the wireless communication, and therefore it is possible to reduce a work load imposed on the user who otherwise confirms the content of the wireless communication setup information on the wireless network relay device and sets the content to the other wireless network relay device. Further, with this configuration, the other wireless network relay device requires no provision of input means for the user to set the wireless communication setup information thereto or of display means for displaying an input result thereon, thereby minimizing production cost of the other wireless network relay device.

A recording medium according to the present invention is the recording medium non-volatilely recording therein a program for controlling a wireless network relay device, in which the program causes the wireless network relay device to realize the functions of: receiving wireless communication setup information from another wireless network relay device to which the wireless communication setup information used for performing wireless communication with a client is pre-set; and performing wireless communication with the client by using the received wireless communication setup information.

With the configuration described above, the wireless communication setup information that is pre-set to the other wireless network relay device is sent therefrom, and wireless communication is performed by using the received wireless communication setup information, and therefore, the client enabled to perform wireless communication using the wireless communication setup information is allowed to wirelessly connect to the other wireless network relay device at a location where the wireless network relay device is not placed, and to the wireless network relay device at a location where it is placed. In addition, the wireless communication is performed by using the wireless communication setup information sent from the other wireless network relay device, and therefore it is possible to reduce a work load imposed on the user who otherwise confirms the content of the wireless communication setup information on the other wireless network relay device and sets the content to the wireless network relay device. Further, with this configuration, the wireless network relay device requires no provision of input means for the user to set the wireless communication setup information thereto or of display means for displaying an input result thereon, thereby suppressing a production cost of the wireless network relay device.

It will be appreciated that the present invention can be realized in various modes such as a method for controlling a wireless network relay device, a computer program for controlling the aforementioned device, and a recording medium recording the computer program therein.

### BRIEF DESCRIPTION OF THE SEVERAL VIEWS OF THE DRAWINGS

FIG. 1 is a simplified explanatory diagram illustrating the configuration of a wireless network system as one embodiment of the present invention;

FIG. 2 is an explanatory diagram representing a second connection mode of the wireless network system;

FIG. 3 is a block diagram illustrating configurational details of a portable access point of the first embodiment;

FIG. 4 is an explanatory diagram illustrating configurational details of a home gateway of the first embodiment;

FIG. 5 is a sequence chart representing procedural flows in a setup updating process executed in the wireless network system of the first embodiment;

FIG. 6 is an explanatory diagram illustrating a second connection mode of the wireless network system, prior to the execution of the setup updating process;

FIG. 7 is an explanatory diagram illustrating the configuration of the home gateway after execution of the setup updating process;

FIG. 8 is an explanatory diagram illustrating the first connection mode of the wireless network system after execution of the setup updating process;

FIG. 9 is a sequence chart representing procedural flows in a setup updating process executed in a wireless network system of a second embodiment;

FIG. 10 is a description diagram showing a configuration of a home gateway of the second embodiment after execution of the setup updating process;

FIG. 11 is an explanatory diagram representing a first connection mode of the wireless network system of the second embodiment after execution of the setup updating process;

FIG. 12 is a simplified explanatory diagram illustrating the configuration of a wireless network system of a third embodiment;

FIG. 13 is a block diagram illustrating configurational details of a cradle that is illustrated in FIG. 12;

FIG. 14 is a block diagram illustrating configurational details of a home gateway of the third embodiment;

FIG. 15 is a block diagram illustrating configurational details of a portable access point of a fourth embodiment;

FIG. 16 is a block diagram illustrating configurational details of a home gateway of the fourth embodiment;

FIG. 17 is a sequence chart representing procedural flows in a setup updating process executed in a wireless network system of the fourth embodiment; and

FIG. 18 is a sequence chart representing procedural flows in a setup updating process executed in a wireless network system of a fifth embodiment.

### DETAILED DESCRIPTION OF THE INVENTION

### A. First Embodiment

A1. System Configuration

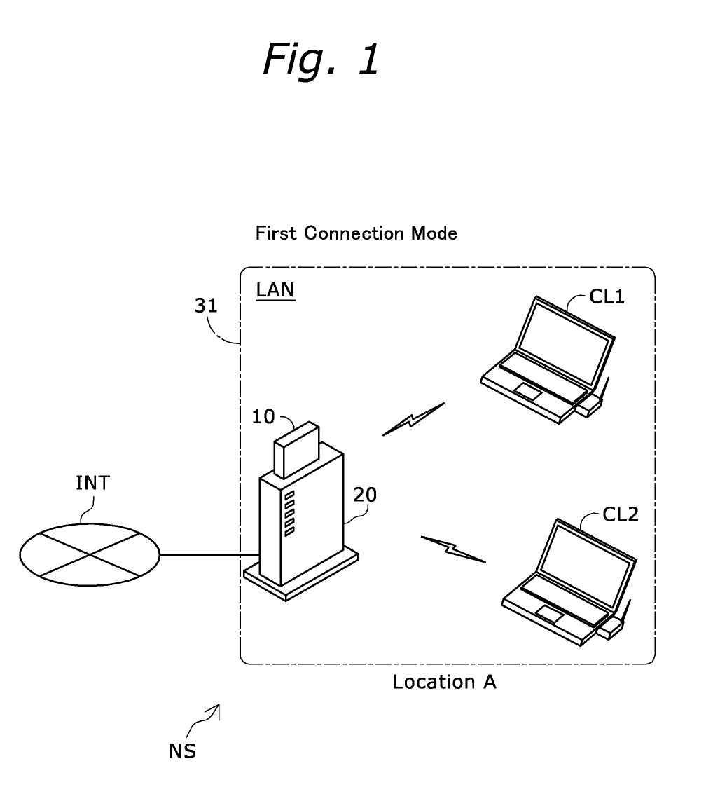

Reference is made to FIG. 1, a simplified explanatory diagram illustrating the configuration of a wireless network system according to a first embodiment of the present invention. A wireless network system NS includes a home gateway 20, and a portable access point 10. The wireless network system NS is a system for connecting clients CL1 and CL2 to the Internet INT. The wireless network system NS assumes a plurality of connection modes relating to the home gateway 20 and portable access point 10. In the connection mode represented in FIG. 1 (first connection mode) the home gateway 20 is connected to the Internet INT via an access line (e.g., an optical line or an asymmetric digital subscriber line (ADSL), not shown). The portable access point 10 is physically connected to (in contact with) the home gateway 20. It should be understood that the two clients CL1 and CL2 are connected to the home gateway 20 by way of wireless communications. In the first connection mode, the wireless communicating function of the portable access point 10 is suspended, as described later.

In the first connection mode, the portable access point 10 and the home gateway 20 are both disposed in the same location (Location A). “Disposed in the same location” means the devices are disposed physically adjoining each other. For example, according to the first connection mode of the present embodiment, the portable access point 10 and the home gateway 20 are disposed physically in contact with each other in a user's home or at an away destination. And in the first connection mode, the two clients CL1 and CL2 are also disposed physically adjoining (i.e., they are disposed in Location A) the portable access point 10 and the home gateway 20. Specifically, for example, the two clients CL1 and CL2 are placed within a range where the portable access point 10 and the home gateway 20 can receive radio signals output from the two clients CL1 and CL2 in a user's home or at an away destination. In the first connection mode, the home gateway 20 and two clients CL1 and CL2 form a wireless LAN 31 Location A. Specifically, the home gateway 20 operates as a wireless LAN access point, while the two clients CL1 and CL2 each operates as a wireless LAN client. Further, the home gateway 20 also functions as a router, and the two clients CL1 and CL2 can be connected to the Internet INT via the home gateway 20 in the first connection mode. According to the present embodiment, each of the two clients CL1 and CL2 is a general personal computer (PC) having the function of a wireless LAN client, and therefore the description is not provided herein. It will be appreciated that game machines, mobile telephone terminals or the like may be adopted instead of the personal computers as the two clients CL1 and CL2.

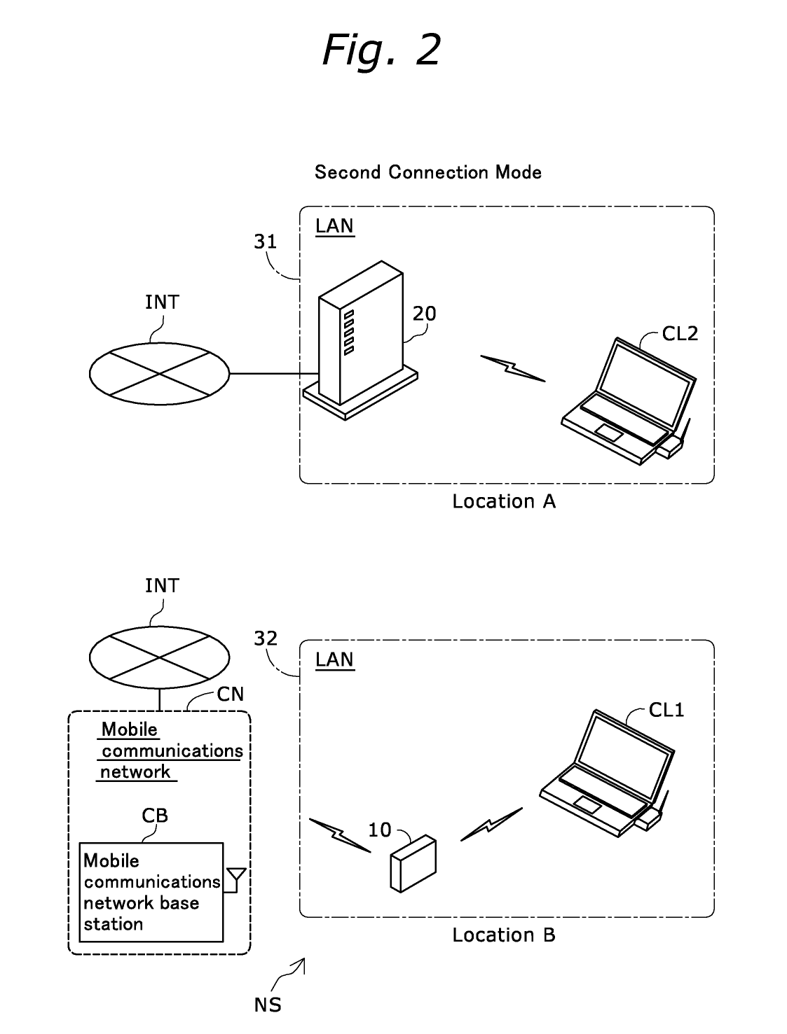

Reference is made to FIG. 2, an explanatory diagram representing a second connection mode of the wireless network system. In the second connection mode, individual components are placed in two locations. Specifically, the home gateway 20 and client CL2 are place at a location A as shown in the upper unit of FIG. 2, while the portable access point 1 and client CL1 are placed at a location B as shown in the lower unit of FIG. 2. In the second connection mode, the location A is physically substantially apart from the location B. That is, the client CL1 and the gateway 20 are placed mutually apart, for example, between a user's home and at an away destination, that is, mutually apart to an extent that a radio signal output from either one of them cannot be received by the other.

In the second connection mode, the portable access point 10 and the home gateway 20 form a wireless LAN 32 in the location B. Specifically, the portable access point 10 operates as a wireless LAN access point, while the client CL1 operates as a wireless LAN client in the second connection mode. The portable access point 10 has functionality for performing wireless communication with mobile base stations in a mobile communications network CN and that of a router, in addition to the function of a LAN access point. It will be appreciated that the mobile communications network CN may adopt, for example, a third-generation (3G)/high speed packet access (HSPA) line. In the second connection mode, the client CL1 can be connected to the Internet INT via the portable access point 10 and the mobile communication network CN.

The second connection mode can form, for example, when a user detaches the portable access point 10 from the home gateway 20 and moves the client CL1 and the portable access point 10 to Location B, transitioning from the first connection mode shown in FIG. 1. Further, the first connection mode can form, for example, when the user brings back the client CL1 and the portable access point 10 to Location A and connects the portable access point 10 to the home gateway 20, transitioning from the second connection mode shown in FIG. 2. The wireless network system NS carries out a setup updating process (described later) so as to enable the client CL1 to be continuously connected to the Internet INT even when there is a change in connection mode.

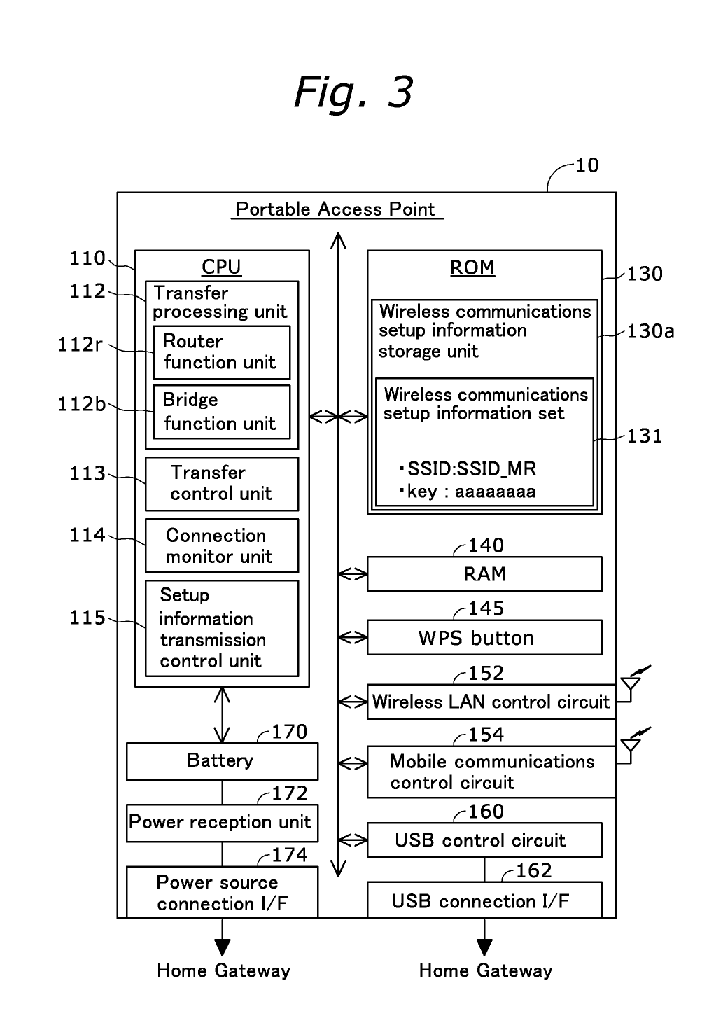

Reference is made to FIG. 3, is a block diagram illustrating configurational details of a portable access point of the first embodiment. The portable access point 10 includes a central processing unit (CPU) 110, read only memory (ROM) 130, random access memory (RAM) 140, a Wi-Fi protected setup (WPS) button 145, a wireless LAN control circuit 152, a mobile communication control circuit 154, a Universal Serial Bus (USB) control circuit 160, a USB connection interface (I/F) 162, battery 170, a power reception unit 172, and a power source connection I/F 174.

The CPU 110 executes a packet-relaying application program stored in the ROM 130, thereby functioning as a transfer processing unit 112 and a transfer control unit 113. The transfer processing unit 112 includes a router function unit 112r and a bridge function unit 112b, and transfers a packet (i.e., a layer 3 packet and a layer 2 frame) to a destination based on a destination address, the packet that is input via respective communication interfaces (i.e., the wireless LAN control circuit 152, mobile communication control circuit 154, and USB connection I/F 162). The transfer control unit 113 controls the transfer processing unit 112.

Further, the CPU 110 executes a wireless communication setup information-updating application program stored in the ROM 130, thereby functioning as a connection monitor unit 114 and a setup information transmission control unit 115. The connection monitor unit 114 monitors connection of the portable access point 10 to the home gateway 20. In a setup updating process (described later), the setup information transmission control unit 115 sends wireless communication setup information that the access point itself is configured with to the home gateway 20. Further, the setup information transmission control unit 115 sends the wireless communication setup information to a wireless LAN client when the WPS button 145 is pressed.

The wireless LAN access point and a wireless LAN client are configured in common with the wireless communication setup information, used for communications in a wireless LAN. The present embodiment is configured to adopt a Service Set Identifier (SSID) and a security key for the wireless communication setup information. Here, in the present embodiment, each device is configured with the same wireless LAN security class (scheme). The wireless LAN security class means an encryption class (i.e., a scheme) of data exchanged on a wireless LAN, and may adopt the Wired Equivalent Privacy (WEP), Wi-Fi Protected Access (WEP) and the like. The “Security key” of the wireless communication setup information means an encryption key used in a pre-set encryption scheme.

The ROM 130 includes a wireless communication setup information storage unit 130a in addition to storing therein the aforementioned individual application programs. The wireless communication setup information storage unit 130a pre-stores therein a wireless communications setup-information set 131. As shown in FIG. 3, the wireless communications setup-information set 131 stores therein an SSID “SSID_MR” and a security key “aaaaaaaa.” The wireless communications setup-information set 131 is information used for the wireless communication between the portable access point 10 and the client CL1, and is pre-set by a user.

The WPS button 145 is a button that is in compliance with a specification prescribed by the Wi-Fi alliance, and is used for notifying a client connected to the portable access point 10 of the wireless communications setup-information set 131, so that the client may be configured with the wireless communications setup-information set 131.

The wireless LAN control circuit 152 includes a modulator, an amplifier and an antenna, operates as an access point of a wireless LAN in compliance with, for example, IEEE 802.11a/b/g, and wirelessly communicates with a wireless LAN client. The mobile communication control circuit 154 includes a modulator, an amplifier, and an antenna, and wirelessly communicates with a base station of a mobile communication network as a terminal of a mobile communication in compliance with, for example, 3G/HSPA.

The USB control circuit 160 controls exchange of data in compliance with the USB standard. The USB connection I/F 162 is connected to the USB control circuit 160 and constitutes a physical connection I/F group compliant with the USB standard. The USB connection I/F 162 is connected (i.e., contacted) to a USB connection I/F (described later) of the home gateway 20 when the portable access point 10 is connected thereto. The power reception unit 172 receives power supplied from the home gateway 20 via the power source connection I/F 174 and supplies the battery 170 with the power. The power source connection I/F 174 is connected (i.e., contacted) to a power source connection I/F (described later) of the home gateway 20 when the portable access point 10 is connected thereto. The power source connection I/F 174 transfers power to the power reception unit 172, the power supplied via the power source connection I/F (described later) of the home gateway 20.

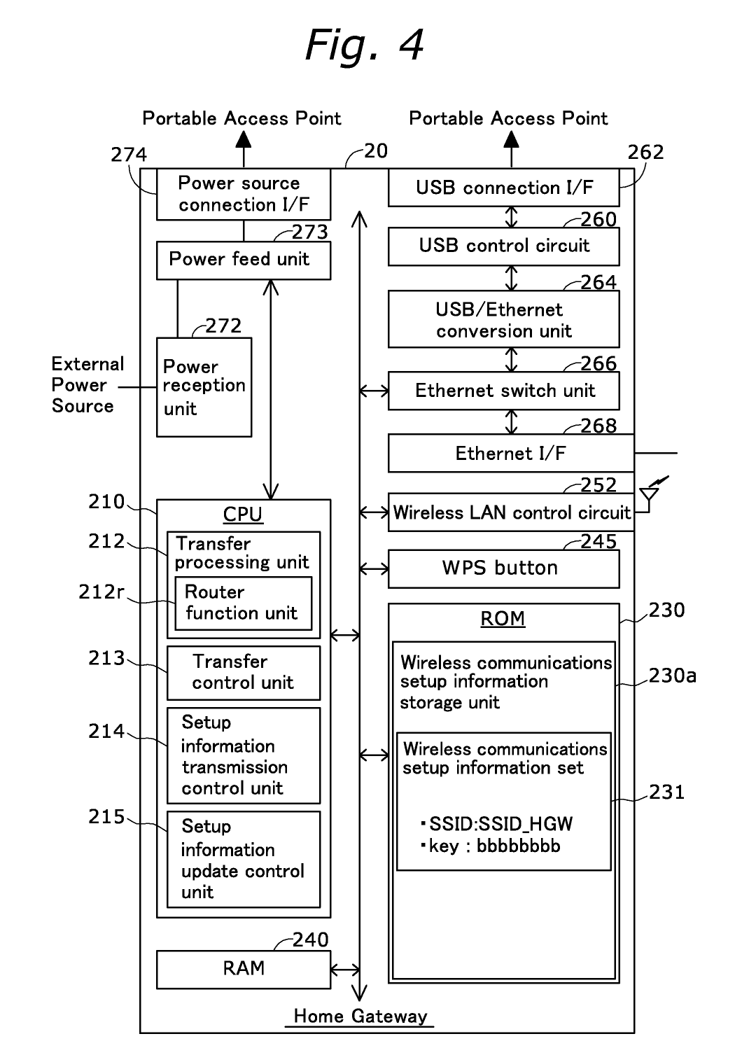

Reference is made to FIG. 4, an explanatory diagram illustrating configurational details of a home gateway of the first embodiment. The home gateway 20 includes a CPU 210, ROM 230, RAM 240, a WPS button 245, a wireless LAN control circuit 252, a USB control circuit 260, a USB connection I/F 262, an Ethernet (Registered Trademark) I/F 268, an Ethernet switch unit 266, a USB/Ethernet conversion unit 264, a power reception unit 272, a power feed unit 273, and a power source connection I/F 274.

The CPU 210 executes a packet-relaying application program stored in the ROM 230, thereby functioning as a transfer processing unit 212 and a transfer control unit 213. The transfer processing unit 212 includes a router function unit 212r. The transfer processing unit 212 is similar to the transfer processing unit 112 of the portable access point 10 shown in FIG. 3, and therefore the description is not provided herein. Likewise, the router function unit 212r and transfer control unit 213 are respectively similar to the router function unit 112r and transfer control unit 113 of the portable access point 10 shown in FIG. 3, and therefore the descriptions are not provided herein.

Further, the CPU 210 executes a wireless communications setup information-updating application program stored in the ROM 230, thereby functioning as a setup information transmission control unit 214 and a setup information update control unit 215. The setup information transmission control unit 214 sends wireless communication setup information to a wireless LAN client when the WPS 245 is pressed. The setup information transmission control unit 214 is compliant with so-called multiple SSID. The multiple SSID means a function capable of setting a plurality of items of wireless communication setup information and carrying out wireless communication using an individual item of the wireless communication setup information. Therefore, the setup information transmission control unit 214 is capable of sending any item of the wireless communication setup information of the plurality of items thereof to a wireless LAN client. In the setup updating process (described later), the setup information update control unit 215 updates the wireless communication setup information (i.e., adds a wireless communications setup information set) that to the gateway itself is configured with.

The ROM includes a wireless communication setup information storage unit 230a in addition to storing the aforementioned individual application programs. The wireless communication setup information storage unit 230a pre-stores therein a wireless communications setup-information set 231. As shown in FIG. 4, the wireless communications setup-information set 231 stores therein an SSID “SSID_HGW” and a security key “bbbbbbbb.” The wireless communications setup-information set 231 is information used for the wireless communication between the home gateway 20 and the client CL2, and is pre-set by the user.

The WPS button 245 is the same as the WPS button 145 of the portable access point 10 shown in FIG. 3, and therefore the description is not provided herein. Likewise, the wireless LAN control circuit 252 and the USB control circuit 260 are respectively similar to the wireless LAN control circuit 152 and the USB control circuit 160 of the portable access point 10 shown in FIG. 3, and therefore the descriptions are not provided herein.

The USB connection I/F 262 constitutes a physical connection I/F group in compliance with the USB standard and is connected (i.e., contacted) to the USB connection I/F 162 of the portable access point 10 when it is connected to the home gateway 20.

The Ethernet I/F 268 processes the layer 1 and 2 protocols of the Ethernet. The Ethernet I/F 268 is connected to a network cable for connecting to an access line (not shown). The Ethernet switch unit 266 is connected to the Ethernet I/F 268 and the USB/Ethernet conversion unit 264. The Ethernet switch unit 266 relays an Ethernet frame input from the Ethernet I/F 268 and the USB/Ethernet conversion unit 264 in accordance with a destination Media Access Control (MAC) address.

The USB/Ethernet conversion unit 264 is connected to the USB control circuit 260 and the USB/Ethernet conversion unit 264. The USB/Ethernet conversion unit 264 converts a USB packet received from the USB control circuit 260 into an Ethernet frame and outputs it to the Ethernet switch unit 266. Further, the USB/Ethernet conversion unit 264 converts an Ethernet frame received from the Ethernet switch unit 266 into a USB packet and outputs it to the USB control circuit 260.

The power reception unit 272 receives power supplied from an external power source and supplies the power to the power feed unit 273. The power feed unit 273 supplies the power received from the power reception unit 272 to the home gateway 20 via the power source connection I/F 274 when the portable access point 10 is connected to the home gateway 20.

A2. Setup Updating Process

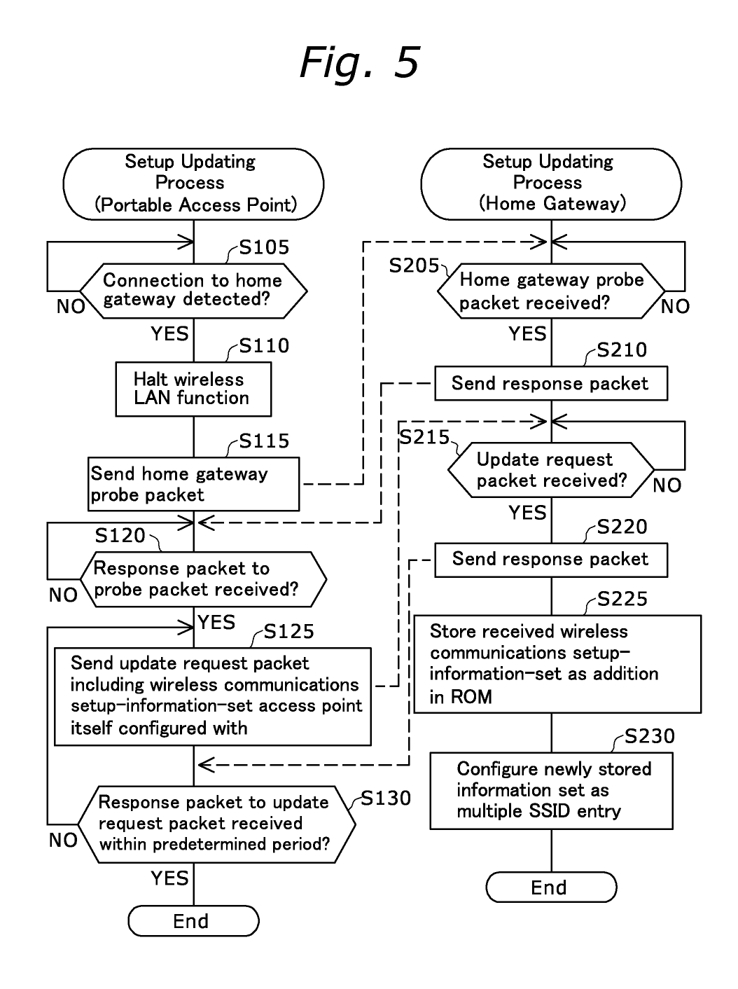

Reference is made to FIG. 5, a sequence chart representing procedural flows in a setup updating process executed in the wireless network system of the first embodiment. Referring to FIG. 5, the left side shows a flowchart of a procedure executed at the portable access point 10, while the right side shows a flowchart of a procedure executed at the home gateway 20. When the power to the portable access point 10 and home gateway 20 is turned on, the setup updating process is respectively performed therein.

In the portable access point 10, the connection monitor unit 114 monitors whether the portable access point 10 is connected to the home gateway 20 (step S105; simply “S105” hereinafter). The monitoring is realized by, for example, presence of power feed to the power source connection I/F 174, or by, for example, a connection detection sequence between devices in accordance with the USB standard.

In the above described S105, if connection between the portable access point 10 and the home gateway 20 is detected (Yes for S105), the setup information transmission control unit 115 causes the wireless LAN control circuit 152 to stop operating, at the portable access point 10 (S110). For example, when the portable access point 10 and the client CL1 return to the location A, changing to the first connection mode shown in FIG. 1 from the second connection mode shown in FIG. 2, it is determined as an event of connecting the portable access point 10 to the home gateway 20 so that the wireless communication function (i.e., a function of communication between a wireless LAN access point and a wireless LAN client) of the portable access point 10 is stopped. The reason for the wireless communication function of the portable access point 10 being stopped when it is determined as an event of connecting the portable access point 10 to the home gateway 20 is to suppress generation of noise interference or radio wave interference between the portable access point 10 and the home gateway 20.

At the portable access point 10, the setup information transmission control unit 115 controls the USB control circuit 160 so as to output (i.e., broadcast) a home gateway probe packet via the USB connection I/F 162. The home gateway probe packet includes a MAC address of the portable access point 10.

At the home gateway 20, the setup information update control unit 215, upon the power being switched on, monitors reception of a home gateway probe packet via the USB connection I/F 262 (S205). The setup information update control unit 215, when detecting the reception of the home gateway probe packet (Yes for S205), sends (i.e., responds with) a response packet by handling the MAC address included in the aforementioned packet as a destination address (S210). The response packet includes the MAC address of the home gateway 20.

At the portable access point 10, the setup information transmission control unit 115 monitors reception of a response packet (S120) after sending a home gateway probe packet (i.e., after the above described S115). Upon detecting the reception of the response packet (Yes for S120), the setup information transmission control unit 115 sends, to the home gateway 20 via the USB connection I/F 162, an update request packet including the wireless communications setup information that is set to the setup information transmission control unit 115 itself (S125). As shown in FIG. 3, the portable access point 10 pre-stores therein a wireless communications setup-information set 131 (i.e., the SSID “SSID_MR” and security key “aaaaaaaa”). Therefore, the setup information transmission control unit 115 sends an update request packet including the wireless communications setup-information set 131 to the home gateway 20 in step S125.

At the home gateway 20, the setup information update control unit 215 monitors reception of an update request packet (S215) after sending the response packet (i.e., after the above described S210). Upon detecting the reception of the update request packet (Yes for S215), the setup information update control unit 215 sends a response packet to the portable access point 10 (S220). Further, the setup information update control unit 215 stores the wireless communications setup information included in the received update request packet in the ROM 230 (S225). As described above, the home gateway 20 supports the multiple SSID and therefore is capable of being configured with a plurality of items of the wireless communications setup information. The setup information update control unit 215 stores therein the wireless communications setup information set received from the portable access point 10, adding to the already stored wireless communications setup information set. The setup information update control unit 215 controls the setup information transmission control unit 214 so as to set (i.e., recognize), as an entry of a multiple SSID, the wireless communications setup information set additionally stored in the ROM in S225 (S230).

At the portable access point 10, the setup information transmission control unit 115 determines whether a response packet is received from the home gateway 20 in response to the update request packet within a predefined period (S130) after sending the update request packet (i.e., after the above described S125). If receiving no response packet within the predefined period (No for S130), the setup information transmission control unit 115 returns to the above described step S125 and re-sends the update request packet. In contrast, if receiving a response packet within the predefined period in response to the update request packet (Yes for S130), the setup information transmission control unit 115 ends the setup updating process.

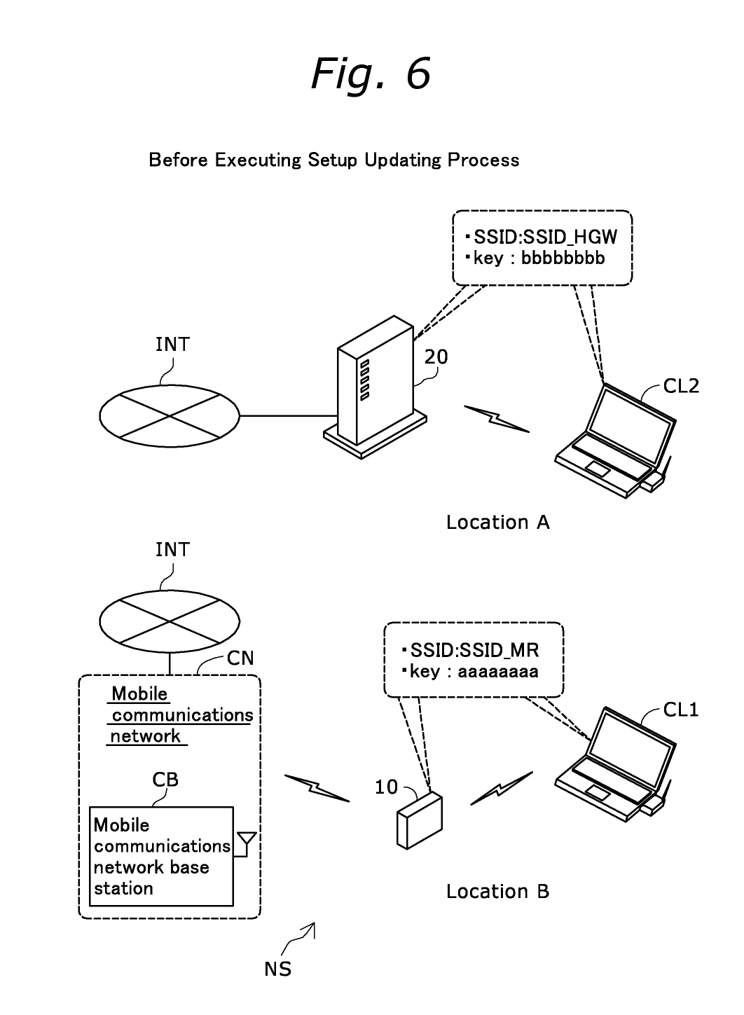

Reference is made to FIG. 6, an explanatory diagram illustrating a second connection mode of the wireless network system before executing setup updating process.

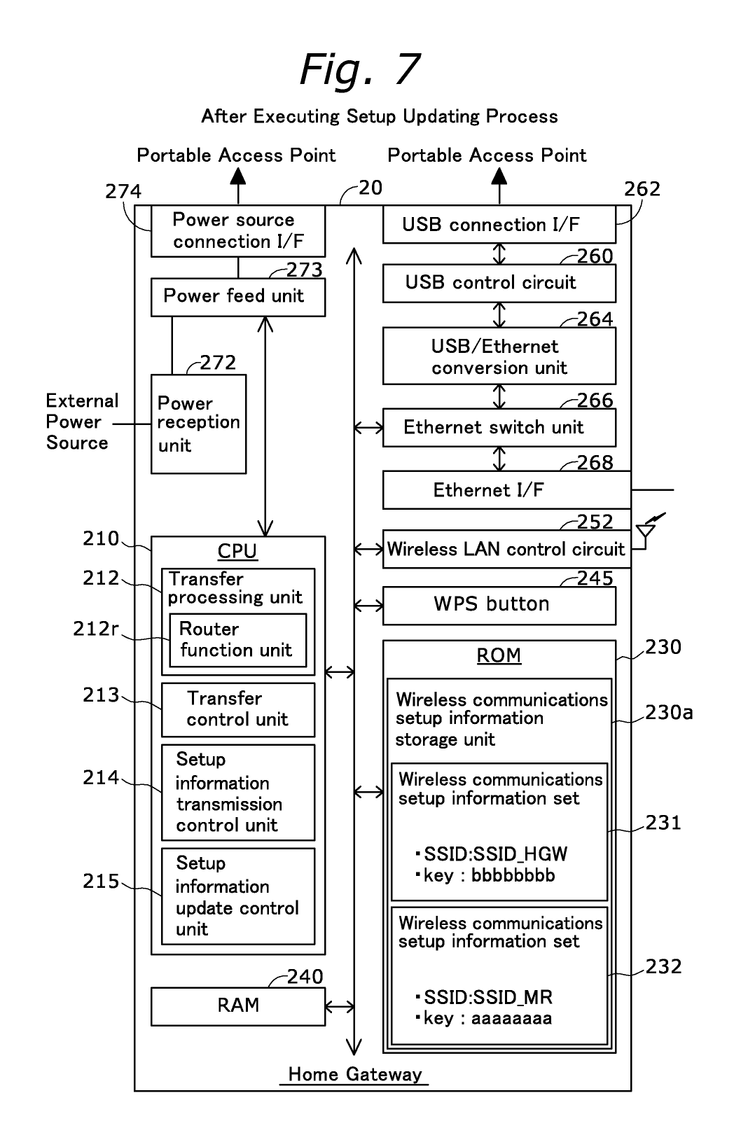

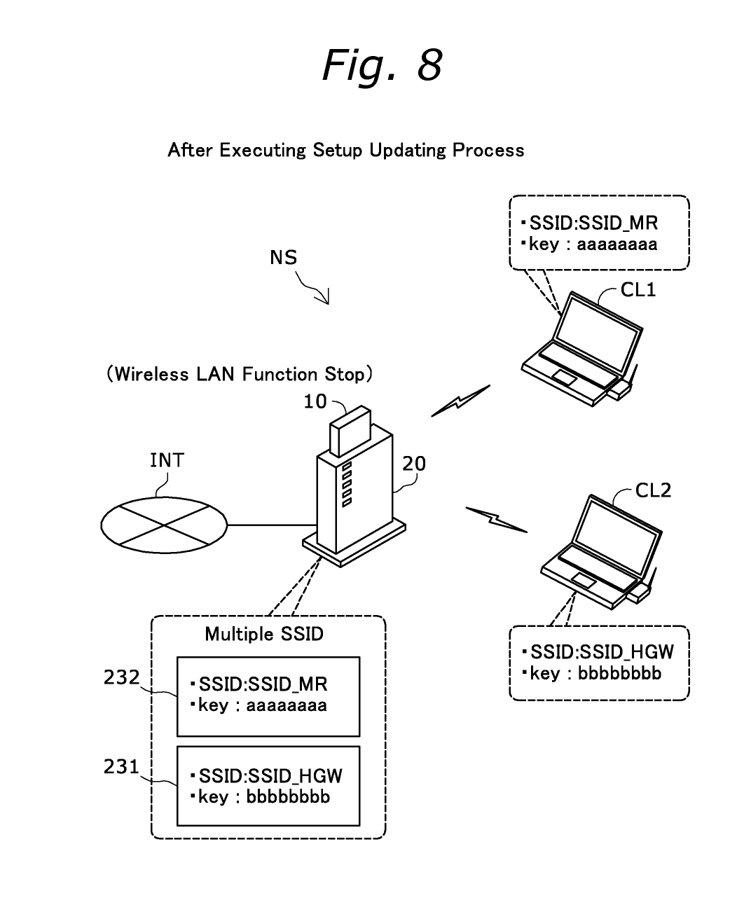

FIG. 7 is a description diagram showing a configuration of the home gateway after executing the setup updating process. FIG. 8 is a description diagram showing a first connection mode of the wireless network system after executing the setup updating process.

As shown in FIG. 6, a wireless network system NS is in a second connection mode before executing setup updating process, the mode in which the home gateway 20 and the client CL2 each has both an SSID “SSID_HGW” and a security key “bbbbbbbb” set thereto. Further, the portable access point 10 and the client CL1 each has both an SSID “SSID_MR” and a security key “aaaaaaaa” set thereto.

When the portable access point 10 and the client CL1 are brought back to the location A, that is, the connection mode is changed from the first connection mode shown in FIG. 6, with the portable access point 10 connected to the home gateway 20 as shown in FIG. 8 and the setup updating process executed, a wireless communications setup-information set 232 is additionally stored in the wireless communication setup information storage unit 230a of the home gateway 20 as shown in FIG. 7. The content of the wireless communications setup-information set 232 is the same as that of the wireless communications setup-information set 131 shown in FIG. 3, and therefore “SSID_MR” and “aaaaaaaa” are respectively set as the SSID and the security key. Note that the setup contents of the SSID and security key for the individual clients CL1 and CL2 are the same before and after the setup updating process.

As shown in FIG. 8, the SSID and the security key, which are respectively set to the individual clients CL1 and CL2, are set to the home gateway 20. Therefore in the first connection mode, the client CL1 is enabled to wirelessly connecting to the home gateway 20, in place of connecting to the portable access point 10, and connect to the Internet INT via the home gateway 20. Meanwhile, the client CL2 is still capable of wirelessly connecting to the home gateway 20 even after the setup updating process is carried out, and therefore is connected to the Internet INT via the home gateway 20.

In the wireless network system NS of the first embodiment described above, when the portable access point 10 is connected to the home gateway 20, the wireless communications setup information that is set to the portable access point 10 is sent to the home gateway 20, and is additionally set thereto. Therefore, when the second connection mode is changed to the first connection mode, the client CL1 is enabled to wirelessly connect to the home gateway 20 by using wireless communications setup information and to the Internet INT via the home gateway 20. Further, the portable access point 10 has wireless communication setup information (i.e., a wireless communications setup-information set 231) pre-set thereto, the information used for the wireless communication between the client CL1 and the portable access point 10. Therefore, the client CL1 is enabled to wirelessly connect to the portable access point 10 and to the Internet INT via the portable access point 10.

As described above, the wireless network system NS of the first embodiment is configured to enable the client CL1 to wirelessly connect to the home gateway 20 at the location A where the home gateway 20 is placed, and enable it to wirelessly connect to the portable access point 10 at the location B where the home gateway 20 is not placed.

In addition, when the second connection mode is changed to the first connection mode, the wireless communications setup information set that is set to the portable access point 10 is automatically sent to the home gateway 20 and is set thereto, and therefore it is possible to reduce a work load imposed on the user who otherwise confirms the content of a wireless communications setup-information set 131 and sets the content thereof to the home gateway 20. Further, there is no need to provide the home gateway 20 with input means for the user to set the content of a wireless communications setup-information set 131 or with display means for displaying a result of an input, suppressing an increase in the production cost of the home gateway 20.

In both before and after executing the setup updating process, the home gateway 20 is configured with a wireless communications setup-information set 231, the information used for the wireless communication between the client CL2 and the home gateway 20. Therefore, the client CL2 is enabled to continuously connect to the home gateway 20 in both the first and second connection modes.

Meanwhile, the portable access point 10 sends wireless communications setup information when detecting connection to the home gateway 20, making it possible to suppress a transmission/reception when the portable access point 10 is not connected to the home gateway 20.

### B. Second Embodiment

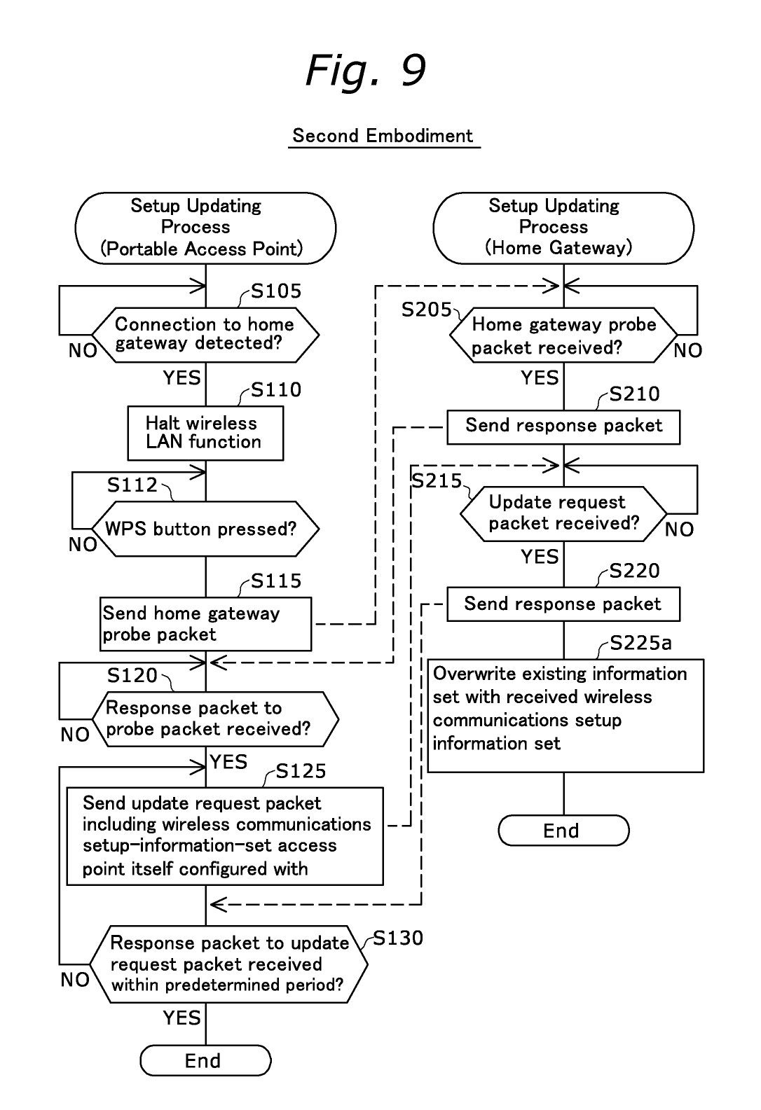

Reference is made to FIG. 9, a sequence chart representing procedural flows in a setup updating process executed in a wireless network system of a second embodiment. Referring to FIG. 9, the left side and the right side are respectively the same as the left side and right side of the sequence chart of the first embodiment shown in FIG. 5, and therefore the description is not provided herein.

The wireless network system of the second embodiment is different from the wireless network system NS of the first embodiment in points as follows: one, the setup information transmission control unit 214 of the home gateway 20 does not support the multiple SSID; two, addition of a step S112 as a procedure at the portable access point 10 in the setup updating process; and three, execution of a step S225a, in place of the steps S225 and S230, as a procedure at the home gateway 20 in the setup updating process. Otherwise, the configuration of the wireless network system of the present embodiment is the same as that of the wireless network system NS of the first embodiment.

According to the setup updating process of the second embodiment, the setup information transmission control unit 115 at the portable access point 10, following step S110, stands by until the WPS button 145 is pressed (S112), and carries out the above described step S115 when the WPS button 145 is pressed. The reason for standing by until the WPS button 145 is pressed and carrying out the processing of S115 and thereafter when the WPS button 145 is pressed as described above is as follows. In the second embodiment, the wireless communications setup information is overwritten at the home gateway 20, and therefore the client CL2 is unable to wirelessly connect to the home gateway 20 unless the wireless communications setup information that is set to the client CL2 is changed, as described later. Accordingly, the user recognizing an event of proceeding with the processing that the wireless communications setup information at the home gateway 20 is changed and that the client CL2 is unable to wirelessly connect to the home gateway 20 is confirmed by way of the user pressing the WPS button 145 so as to prevent the aforementioned processing from proceeding without the user knowing the event.

At the home gateway 20, the setup information update control unit 215 overwrites the wireless communications setup information already stored in the ROM 230 with the wireless communications setup information included in the update request packet and stores therein the overwritten information (S225a), after receiving the update request packet (S215) and sending a response packet (S220).

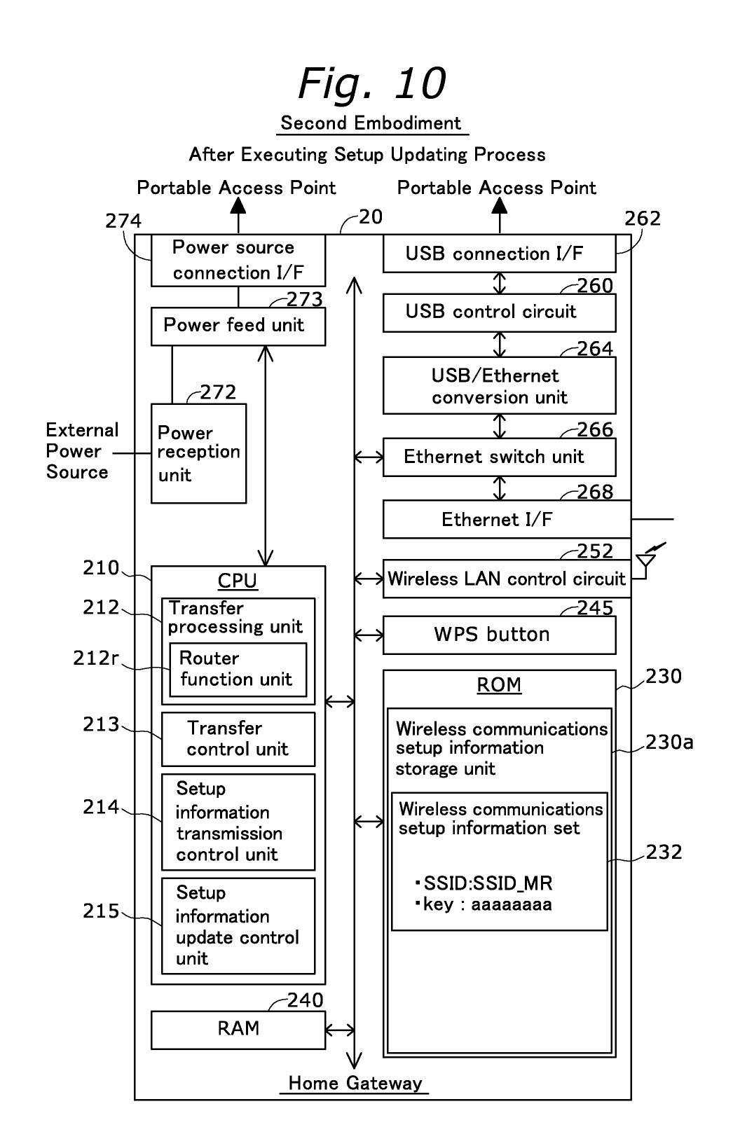

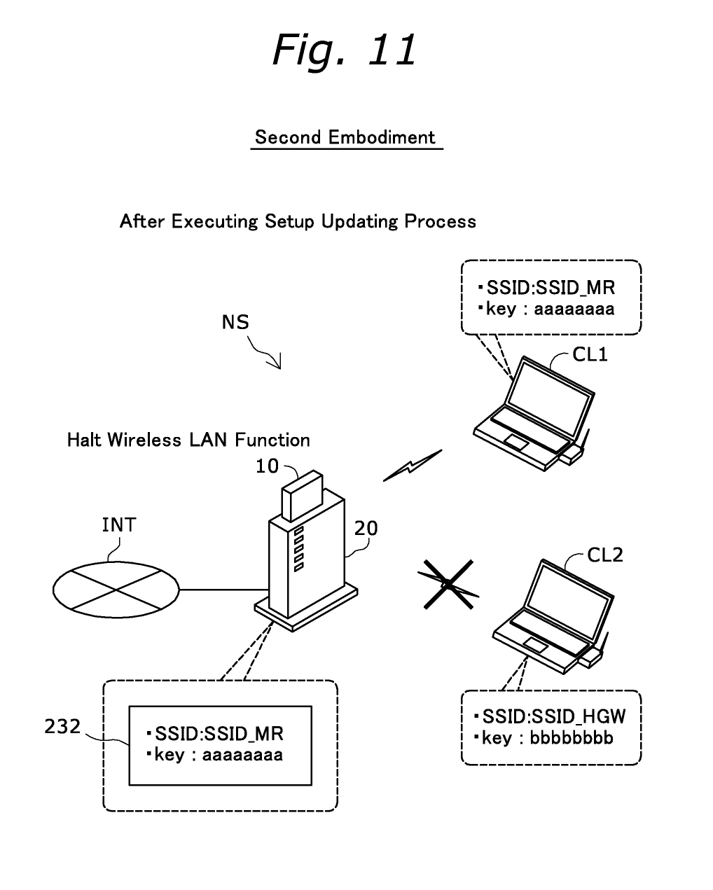

Reference is made to FIG. 10, a description diagram showing a configuration of the home gateway of the second embodiment after execution of the setup updating process. Reference is also made to FIG. 11, an explanatory diagram representing a first connection mode of the wireless network system of the second embodiment after execution of the setup updating process.

When the portable access point 10 and client CL1 are moved to the location A and when the setup updating process of the second embodiment is carried out, that is, the connection mode is changed from the second connection mode shown in FIG. 6 before executing setup updating process, a wireless communications setup-information set 232 (an SSID “SSID_MR” and a security key “aaaaaaaa”) whose contents are the same as those received from the portable access point 10, replacing the wireless communications setup-information set 231 shown in FIG. 4, are stored in the wireless communications setup information storage unit 230a at the home gateway 20 after the setup updating process as shown in FIG. 10.

Therefore, as shown in FIG. 11, the client CL1 is enabled to wirelessly connect to the home gateway 20 and to the Internet INT via the home gateway 20. Note that the home gateway 20 no longer stores the wireless communications setup information (i.e., the wireless communication communications setup-information set 231) used for wireless communication with the client CL2 in the wireless communications setup information storage unit 230a after the setup updating process. Consequently, unlike the first embodiment, the client CL2 of the second embodiment is unable to wirelessly connect to the home gateway 20 after the setup updating process. In this case, the client CL2 is enabled to wirelessly connect to the home gateway 20 when the WPS button 245 is pressed on the home gateway 20 to notify the client CL2 of a wireless communications setup-information set 232 to be set thereto.

As described above, the wireless network system of the second embodiment is configured to enable the client CL1 to wirelessly connect to the home gateway 20 at the location A where the home gateway 20 is placed, likewise the first embodiment, and to wirelessly connect to the portable access point 10 at the location B where the home gateway 20 is placed. In addition, it is possible to adopt a home gateway 20 that does not support the multiple SSID, suppressing a cost for building a wireless network system. Further, the home gateway 20 overwrites the already stored wireless communications setup information with the wireless communications setup information received from the portable access point 10 to store the overwritten information in the ROM 230, reducing a memory space thereof and suppressing a cost for building a wireless network system.

### C. Third Embodiment

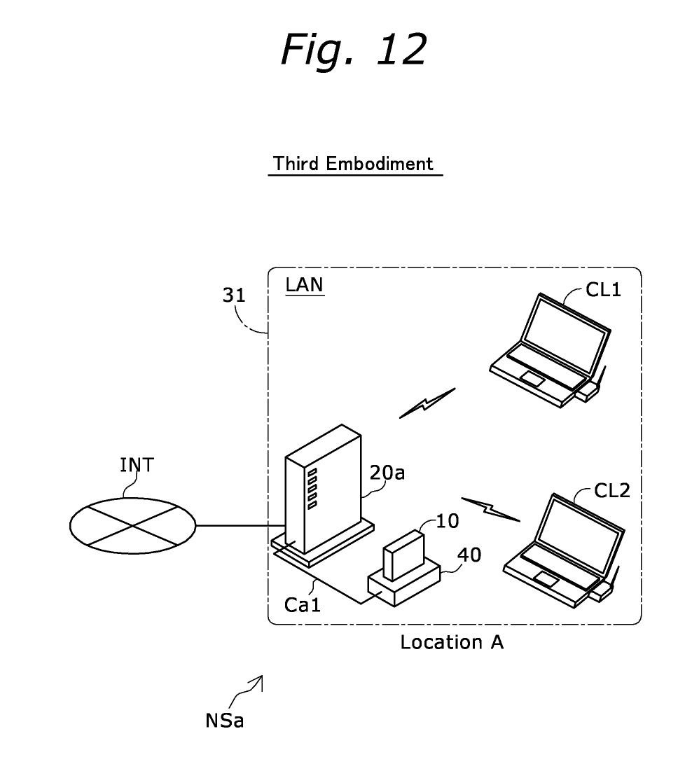

Reference is made to FIG. 12, a simplified explanatory diagram illustrating the configuration of a wireless network system of a third embodiment. FIG. 12 shows a first connection mode of a wireless network system NSa of the third embodiment. The wireless network system NSa of the third embodiment is different from the wireless network system NS of the first embodiment shown in FIG. 1, where the former has the portable access point 10 connected to a home gateway 20a via a cradle 40. Otherwise the configuration of the wireless network system NSa is the same as that of the wireless network system NS of the first embodiment. The cradle 40 is connected to the home gateway 20a by way of a network cable Ca1. When the cradle 40 is physically connected to the portable access point 10 via a contact, the cradle 40 supplies the portable access point 10 with power and mediates data exchange between the portable access point 10 and the home gateway 20a.

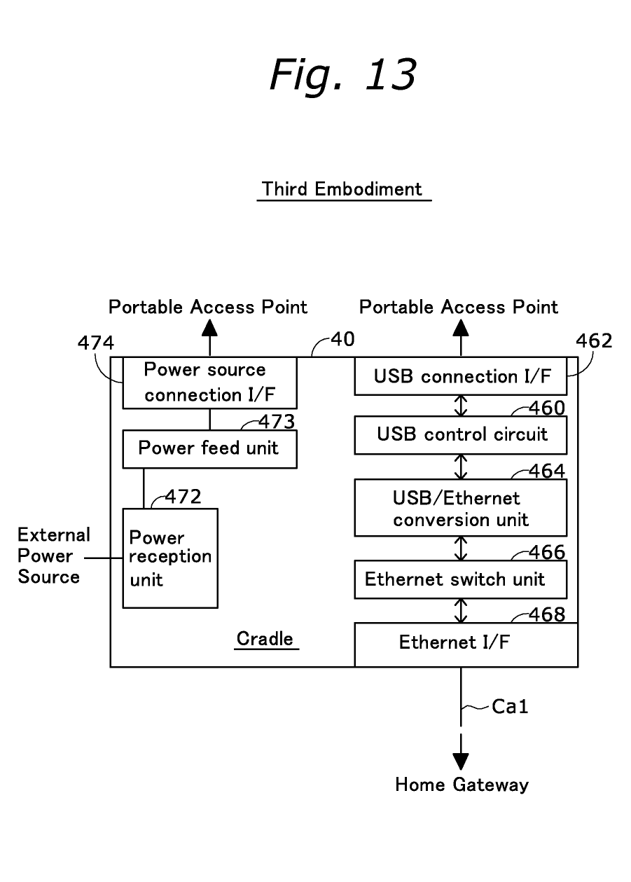

Reference is made to FIG. 13, a block diagram illustrating configurational details of the cradle that is illustrated in FIG. 12. The cradle 40 includes a USB control circuit 460, a USB connection I/F 462, a USB/Ethernet conversion unit 464, an Ethernet switch unit 466, an Ethernet I/F 468, a power reception unit 472, a power feed unit 473, and a power source connection I/F 474.

The USB control circuit 460 has the same function as that of the USB control circuit 260 of the first embodiment shown in FIG. 4, and therefore the description is not provided herein. Likewise, the USB connection I/F 462, the USB/Ethernet conversion unit 464, the Ethernet switch unit 466, the power reception unit 472, the power feed unit 473, and the power source connection I/F 474 are respectively the same as the USB connection I/F 262, the USB/Ethernet conversion unit 264, the Ethernet switch unit 266, the power reception unit 272, the power feed unit 273, and the power source connection I/F 274, which are shown in FIG. 4, and therefore the descriptions are not provided herein.

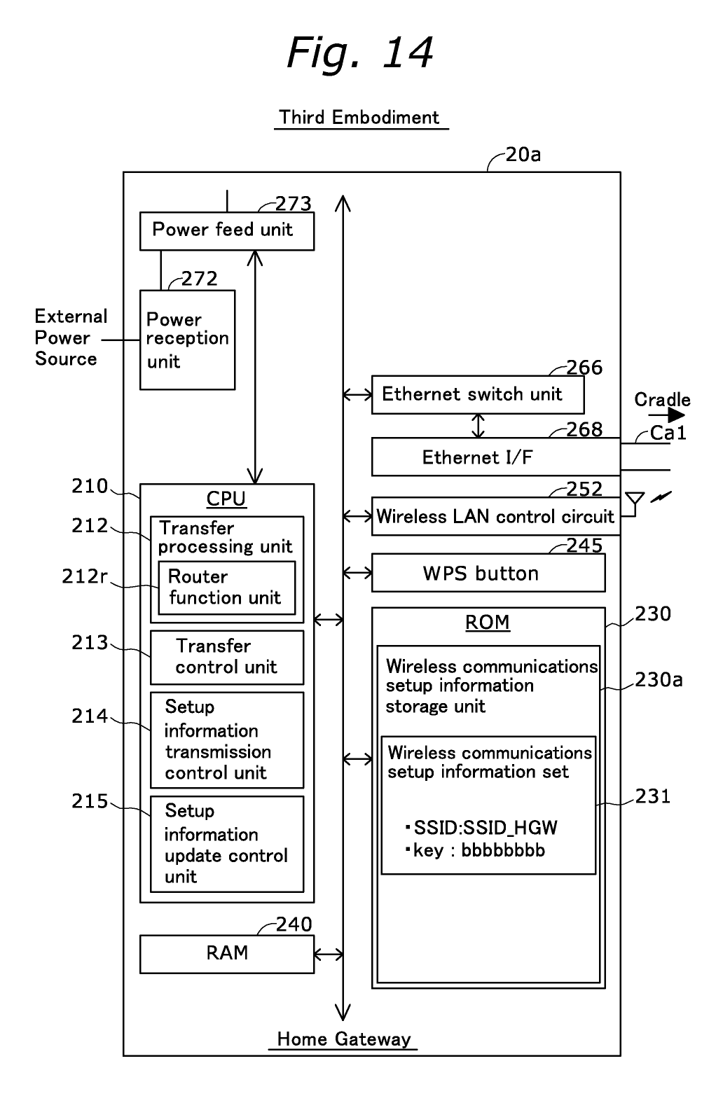

Reference is made to FIG. 14, a block diagram illustrating configurational details of a home gateway of the third embodiment. A home gateway 20a of the third embodiment is different from the home gateway 20 of the first embodiment shown in FIG. 4, where the former includes no USB control circuit 260, USB connection I/F 262, USB/Ethernet conversion unit 264 nor power source connection I/F 274. Otherwise the configuration of the home gateway 20a of the third embodiment is the same as that of the first embodiment. That is, a unit of the functional parts of the home gateway 20 of the first embodiment is realized by the cradle 40 in the third embodiment.

A procedure of setup updating process of the third embodiment is different from that of the setup updating process of the first embodiment shown in FIG. 5, where the former is configured so that the cradle 40 relays information exchange between the home gateway 20a and the portable access point 10. Otherwise, the procedure of the setup updating process of the third embodiment is the same as that of the processing of the first embodiment.

The wireless network system NSa of the third embodiment configured as described above has the same effectiveness as the network system of the first embodiment does. In addition, the cradle 40 carries out USB/Ethernet conversion in the third embodiment, making it possible to realize the wireless network system NSa using a home gateway that has no functional unit for carrying out USB/Ethernet conversion.

### D. Fourth Embodiment

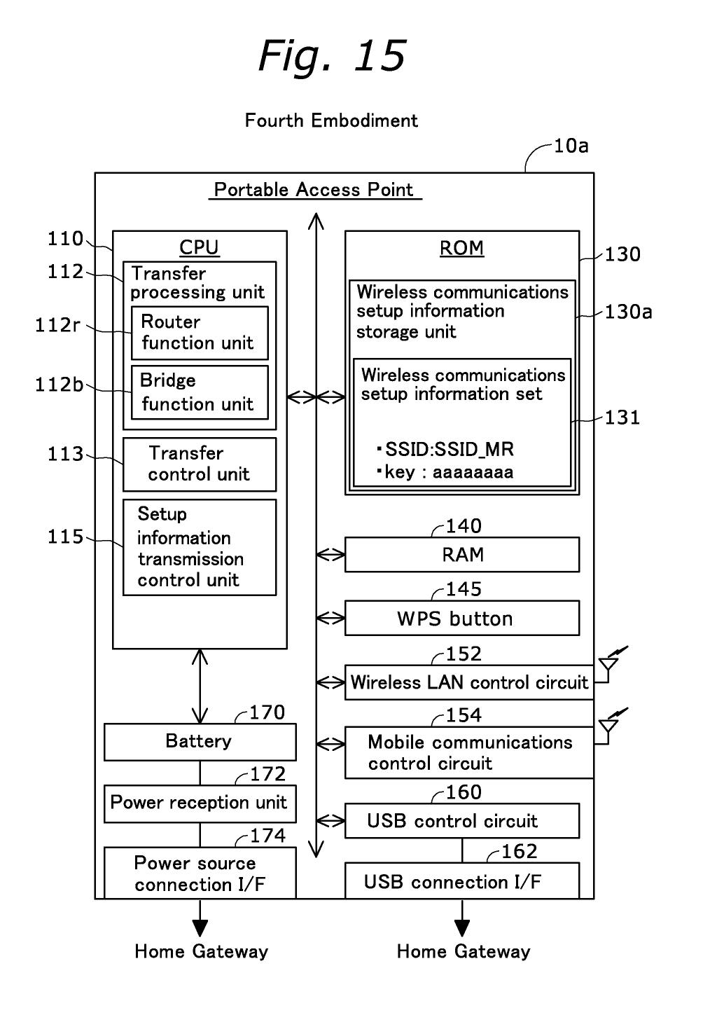

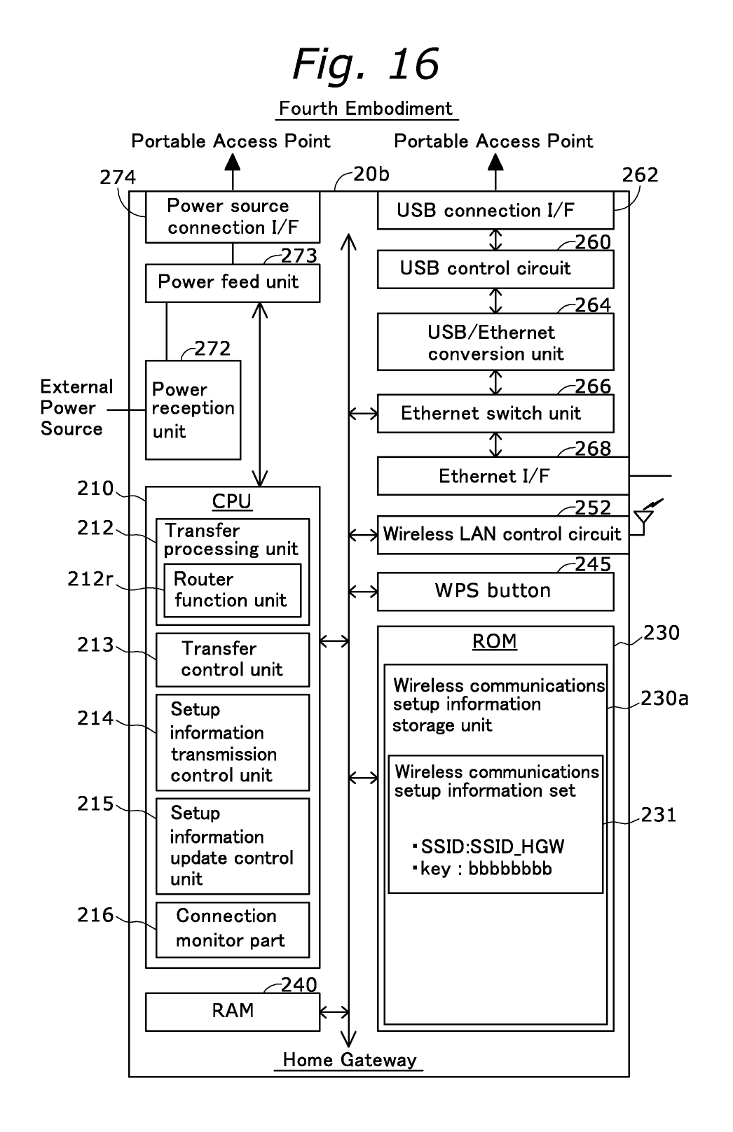

Reference is made to FIG. 15, a block diagram illustrating configurational details of a portable access point of a fourth embodiment. Reference is also made to FIG. 16, a block diagram illustrating configurational details of a home gateway of the fourth embodiment. The portable access point 10a shown in FIG. 15 is different from the portable access point 10 of the first embodiment shown in FIG. 3, where the CPU 110 of the former has no function of carrying out USB/Ethernet conversion. Otherwise the configuration of the portable access point 10a is the same as the portable access point 10 of the first embodiment. The home gateway 20b shown in FIG. 16 is different from the home gateway 20 of the first embodiment shown in FIG. 4, where the CPU 210 of the former functions as a connection monitor unit 216. Otherwise, the configuration of the home gateway 20b is the same as the home gateway 20 of the first embodiment.

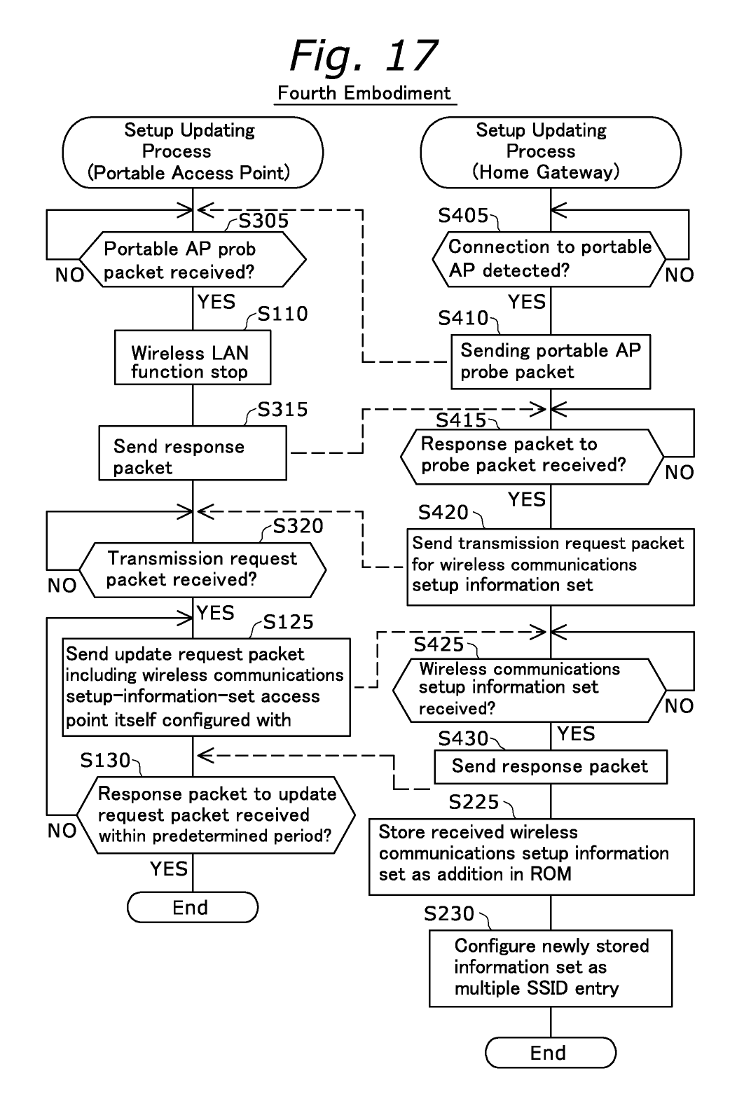

Reference is made to FIG. 17, a sequence chart representing procedural flows in a setup updating process executed in a wireless network system of the fourth embodiment. Referring to FIG. 17, the left side and the right side are the same as the left side and right side of the sequence chart of the first embodiment shown in FIG. 5, and therefore the description is not provided herein. The wireless network system of the fourth embodiment is configured so that when the portable access point 10a is connected to the home gateway 20b, it requests the portable access point 10a for sending a wireless communications setup-information set so that the portable access point 10a sends the wireless communications setup-information set in response to the request.

Specifically at the home gateway 20b, the connection monitor unit 216 monitors whether the portable access point 10a is connected to the home gateway 20b (S405). The processing of the step is similar to that of S105 of the first embodiment shown in FIG. 5.

In step S405, when the connection monitor unit 216 detects the connection of the portable access point 10a to the home gateway 20b (Yes for S405), the setup information update control unit 215 at the home gateway 20b sends (i.e., broadcasts) a portable access point probe packet via the USB connection I/F 262 (S410). The processing of the step is similar to that of S115 shown in FIG. 5.

At the portable access point 10a, the setup information transmission control unit 115, upon turning the power on, monitors reception of a portable access point probe packet via the USB connection I/F 162 (S305). Detecting the reception of the portable access point probe packet (Yes for S305), the setup information transmission control unit 115 carries out the above described step S110 (i.e., stopping of the wireless LAN function) and sends a response packet to the home gateway 20b (S315).

At the home gateway 20b, the setup information transmission control unit 115 stands by until a response packet is received (S415), after the above described S410. Upon receiving the response packet (Yes for S415), the setup information transmission control unit 115 sends a transmission request packet of a wireless communications setup-information set to the portable access point 10a via the USB connection I/F 262 (S420).

At the portable access point 10a, the setup information transmission control unit 115 stands by until a transmission request packet of the wireless communication setup information set is received (S320), after the above described S315. Upon receiving the transmission request packet of the wireless communication setup information set (Yes for S320), the setup information transmission control unit 115 carries out the above described steps S125 and S130. Therefore, the wireless communications setup information pre-stored in the portable access point 10a is sent to the home gateway 20b.

At the home gateway 20b, the setup information update control unit 215 stands by until wireless communications setup information is received (S425), after the above described S420. Upon receiving the wireless communications setup information (Yes for S425), the setup information update control unit 215 sends a response packet to the portable access point 10a (S430). Then the setup information update control unit 215 carries out the above described steps S225 and S230. Therefore, the wireless communications setup-information set sent from the portable access point 10a is additionally stored in the wireless communications setup information storage unit 230a (S225).

The wireless network system of the fourth embodiment configured as described above has the same effectiveness as the wireless network system NS of the first embodiment does. In addition, the portable access point 10a has no function of monitoring connection with the home gateway 20b or actively transmitting a wireless communications setup-information set, enabling reduction of the processing load at the portable access point 10a.

### E. Fifth Embodiment

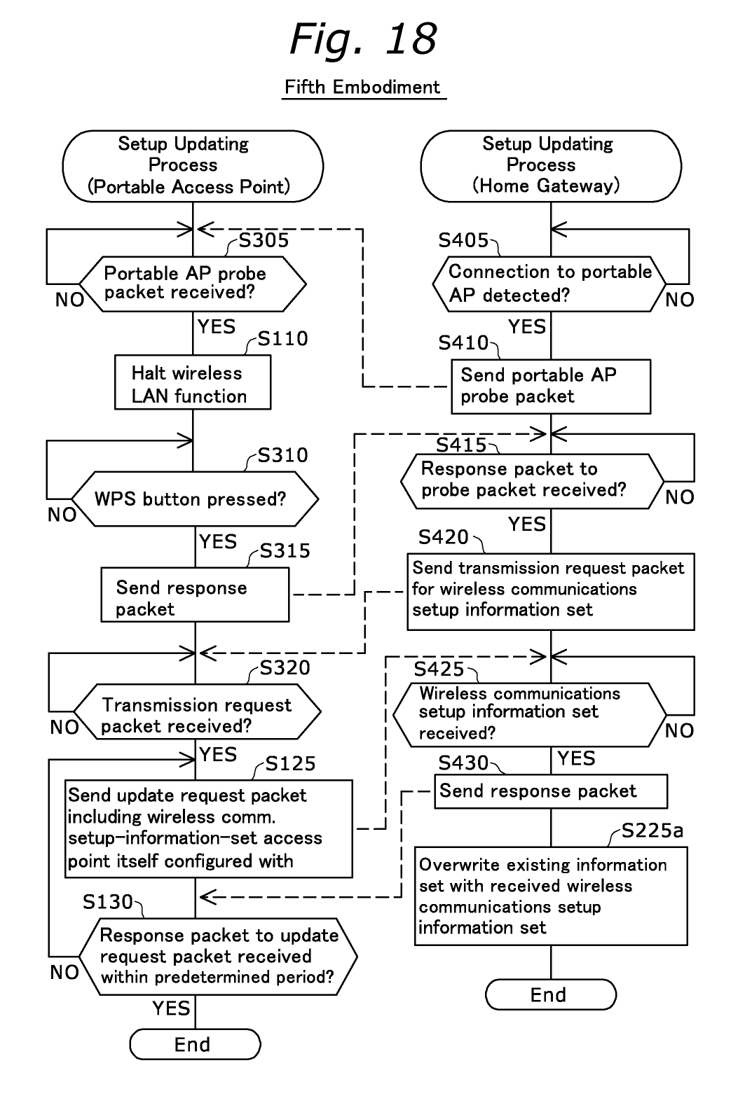

Reference is made to FIG. 18, a sequence chart representing procedural flows in a setup updating process executed in a wireless network system of a fifth embodiment. Referring to FIG. 18, the left side and right side are the same as the left side and right side of the sequence chart of the fourth embodiment shown in FIG. 17, and therefore the description is not provided herein.

The wireless network system of the fifth embodiment is different from the wireless network system of the fourth embodiment in the following points: one, the former includes the home gateway 20b having a setup information transmission control unit 214 that does not support the multiple SSID; two, a step S310 is added as a procedure at the portable access point 10a in setup updating process; three, execution of the step S225a replacing steps S225 and S230 as a procedure at the home gateway 20b in the setup updating process. Otherwise the configuration of the wireless network system of the fifth embodiment is the same as that of the wireless network system of the fourth embodiment.

As shown in FIG. 18, the setup information transmission control unit 115 at the portable access point 10a stands by until the WPS button 145 is pressed (S310), after the above described S110. When the WPS button 145 is pressed (Yes for S310), the setup information transmission control unit 115 performs the above described step S315. The reason for standing by until the WPS button is pressed and then performing the processing S315 and thereafter when the WPS button is pressed is the same as with the second embodiment.

At the home gateway 20b, the setup information update control unit 215 carries out the above described step S225 likewise in the second embodiment. Therefore, a wireless communications setup-information set pre-stored in the home gateway 20b is overwritten with a wireless communication setup information set sent from the portable access point 10a.

The wireless network system of the fifth embodiment configured as described above has the same effectiveness as the wireless network system of the fourth embodiment does. In addition, the wireless network system of the fifth embodiment is allowed to adopt the home gateway 20b that does not support the multiple SSID, likewise the wireless network system of the second embodiment, making it possible to suppress a cost for building a wireless network system. Further, the existing wireless communications setup information is overwritten with the wireless communications setup information received from the portable access point 10a and the overwritten information is stored in the ROM 230 at the home gateway 20b, and therefore it is possible to reduce a memory space thereof and suppress a cost for building the wireless network system.

### Modifications of the Embodiments

The present invention is in no way limited to the above described embodiments or modes thereof, and may rather be embodied in various modes within the spirit and scope of the invention, in the exemplary modes as follows.

### F1. Modification Example 1

The above described individual embodiments are configured to send wireless communications setup information to a home gate way from a portable access point using, as a trigger, an event of the portable access point physically connecting to the home gateway, that is, an event of detecting that the distance between the portable access point and the home gateway is “0” (zero). The present invention, however, is not limited as such. It may be configured to send the wireless communications setup information to the home gate way from the portable access point using, as a trigger, an event of detecting that the distance between the portable access point and the home gateway is equal to or less than a predefined value.

Specifically, it is possible to adopt a configuration that performs: estimating the distance between a portable access point 10 and a home gateway 20 on the basis of a reception signal strength of a beacon wirelessly output from the home gateway 20; determining whether the estimated distance is equal to or less than a predefined value (e.g., a few meters or less); and carrying out the step S110 if the distance is determined to be equal to or less than the predefined value. Such a configuration enables estimation of the distance between the portable access point 10 and the home gateway 20 on the basis of the reception signal strength of a beacon by empirically acquiring in advance a relationship of the reception signal strength with distance to set the relationship to the portable access point 10. In this case, the beacon may be provided to the portable access point 10. Further, the distance between the portable access point 10 and the home gateway 20 may also be estimated by using the reception signal strength of a probe response wirelessly output from the home gateway 20, in place of using the reception signal strength of the beacon.

Further, the distance between the portable access point 10 and the home gateway 20 may also be determined to be equal to or less than a predefined value when prescribed ID information is received from the portable access point 10 or home gateway 20 by using, for example, a short-distance wireless communication (ranging from a few centimeters to a few meters), such as a radio frequency identification (RFID). Note that the determination of “whether the distance between the portable access point 10 and the home gateway 20 is equal to or less than a predefined value” may also be eliminated. A configuration using, for example, wireless communication such as RFID may also proceed with setup updating process using, as a trigger, an event of receiving prescribed ID information by way of the RFID, replacing the above described steps S105 and S405. In such a configuration, a wireless communications setup-information set may also be sent to the portable access point 10 from the home gateway 20 by way of the RFID or the like. That is, typically, if the distance between the portable access point 10 and the home gateway 20 is within a limit allowing the wireless communication with each other, any given configuration that sends a wireless communications setup information set from the portable access point 10 to the home gateway 20 can be adopted to the wireless network system of the present invention.

As is comprehensible from the individual embodiments and the modified embodiments, if the device distance between a portable access point 10 (or 10a) and the home gateway 20 (or 20a or 20b) allows communication with each other, any given configuration that sends wireless communications setup information from the portable access point 10 (or 10a) to the home gateway 20 (or 20a or 20b) can be applied to the wireless network system of the present invention.

### F2. Modification Example 2

In each of the embodiments, wireless communications setup information constitutes an SSID and a security key, the present invention, however, is not limited as such. For example, either one of the SSID and the security key can be adopted as the wireless communications setup information. Further, for example, information representing a security class (i.e., a scheme) in addition to the SSID and the security key may also be adopted as the wireless communications setup information. That is, typically, information including any of the SSID, the security key and the security class information can be adopted as the wireless communications setup information of the present invention.

Further, any given information used for wireless communications, in place of or in addition to the SSID, the security key and the information representing a security class (i.e., a scheme), may be adopted as the wireless communications setup information. For example, in a configuration in which a portable access point 10 and a home gateway 20 has a so-called MAC address restriction function (i.e., a function of rejecting a connection request from a wireless LAN client having a MAC address other than an already registered MAC address), the registered MAC address information may also be adopted as the wireless communications setup information. That is, typically, any given information used for wireless communications can be adopted as the wireless communications setup information of the present invention.

### F3. Modification Example 3

In the second or fifth embodiment, the WPS button 145 is used as means for reporting to the portable access point 10 (or 10a) that a user recognizes proceeding of the processing that the wireless communications setup information at the home gateway 20 (or 20b) is changed and that the client CL2 is unable to wirelessly connect to the home gateway 20 (or 20b), the present invention, however, is not limited as such. For example, the portable access point 10 (or 10a) may also be provided with a specific button different from the WPS button 145 to be used as the report means. Further, the WPS button 245 of the home gateway 20 (or 20b) may also be used as the report means. In this configuration, an event of the WPS button 245 being pressed is preferably reported to the portable access point 10 (or 10a). That is, in general a user interface of choice preferably is arranged in at least one of either the portable access point or the home gateway, for inputting an instruction to store the wireless communications setup information that the portable access point is preconfigured with, by overwriting the information into the home gateway.

Further, the step S112 of the second embodiment and step S310 of the fifth embodiment may be eliminated. That is, it is possible to adopt a configuration in which the processing of step S115 and thereafter and of S315 and thereafter are carried out at the portable access point regardless of the WPS button 145 being pressed.

### F4. Modification Example 4

In each of the embodiments, when the portable access point 10 (or 10a) is connected to the home gateway 20 (or 20a or 20b), the wireless LAN function of the portable access point 10 (or 10a) is stopped. Alternatively, a configuration may keep the wireless LAN function operating. In such a configuration, a countermeasure that disposes a shield between individual devices and a countermeasure that disposed channels having mutually greatly separated frequency bands as radio channels used by the individual devices are preferably provided for suppressing generation of noise interference and radio wave interference between the portable access point 10 (or 10a) and the home gateway 20 (or 20a or 20b).

### F5. Modification Example 5

In the third embodiment, the procedure of setup updating process is the same as with the first embodiment. The procedure may adopt other embodiment or modified embodiment. For example, the hardware configuration of the wireless network system of the second embodiment may be configured the same as the wireless network system NSa so as to carry out the setup updating process of the second embodiment shown in FIG. 9. Also in this configuration, the setup updating process can be realized by the cradle 40 relaying information exchange between the portable access point 10 and the home gateway 20 as with the third embodiment.

### F6. Modification Example 6

In each of the embodiments, the portable access point and the home gateway are used as a wireless network relay device for connecting the clients CL1 and CL2 to the Internet INT. The present invention, however, is not limited as such. Any given device (e.g., a portable phone terminal) having a function of a wireless LAN access point, of performing wireless communication with a mobile base station in a mobile communication network, and of a router may be adopted, in place of the portable access point 10 (or 10a). Further, a stationary device (e.g., a home gateway) may be adopted, in place of a portable device such as the portable access point 10 and the portable phone terminal. In an exemplary case of a wireless network system constituting two home gateways and clients CL1 and CL2, updating of the old home gateway with a new home gateway provides a benefit that the client CL1 can be continuously connected to the Internet INT and that the wireless communication setup information can easily be transferred from the old home gateway to the new home gateway.

Further, the home gateway 20 (or 20a or 20b) may be replaced with any given wireless network relay device, such as a layer-3 switch, the device that is capable of operating as a wireless LAN access point and a router and connecting to the Internet. Further, in each of the embodiments, the home gateway 20 (or 20a or 20b) may not necessarily be connected to the Internet INT. It is possible to adopt a configuration in which, for example, each home gateway 20 (or 20a or 20b) is connected to a LAN or virtual private network (VPN), other than the wireless LAN 31. That is, typically, two wireless network relay devices of choice may be adopted for the wireless network system of the present invention.

### F7. Modification Example 7

The respective configurations of the portable access point 10 (or 10a) and the home gateway 20 (or 20a or 20b) in each of the embodiments are merely examples and may be modified in various shapes and forms. In each of the embodiments, the wireless LAN control circuit 152 or 252 may also be defined as a wireless communication I/F for performing wireless communication in compliance with a general wireless LAN that will be available in the future, in lieu of being limited to the wireless LAN in compliance with the IEEE 802.11a/b/g. Further, the mobile communication control circuit 154 may also be defined as a wireless communication I/F for performing wireless communication in compliance with a general wireless LAN that will be available in the future, such as Long Term Evolution (LTE), a next generation mobile WiMAX (IEEE.802.16m) and a next generation PHS (eXtended Global Platform: XGP), in lieu of being limited to the mobile communication in compliance with the 3G/HSPA.

Further, in each of the embodiments other than the third embodiment, a USB is used as a connection interface for data exchange between the portable access point and the home gateway, another communication interface of choice may be adopted in place of the USB. Meanwhile, the present invention is applicable to general wireless communication in a predetermined wireless network, in lieu of being limited to a wireless LAN and a mobile communication.

Further in the above described embodiments, a unit of configurations realized by the hardware may be replaced with software. Conversely, a unit of configurations realized by the software may be replaced with hardware. Further, in a case where a unit or the entirety of the function of the present invention is realized by software, the software (e.g., a computer program) can be provided by a form stored in a computer-readable recording medium. According to the present invention, the “computer-readable recording medium” includes not only a portable recording medium such as flexible disc and CD-ROM, but also a computer-incorporated internal storage device, such as various RAM and ROM, and an external storage device, such as a hard disc, fixed to the computer. That is, the “computer-readable recording medium” broadly comprehends any given recording media that are capable of permanently, not temporarily, retaining data.

This application is based on, and claims the benefit of priority from, Japanese Pat. App. No. 2011-156281, filed on Jul. 15, 2011, the entirety of which is herein incorporated by reference.

What is claimed is:

1. A wireless network system, comprising:
a first wireless network relay device preconfigured with first wireless communications setup information used in wireless communications with a client; and
a second wireless network relay device;
said first wireless network relay device including
a first communications interface unit for communicating with said second wireless network relay device, and
a first wireless communications setup information transmission unit for transmitting the first wireless communications setup information to said second wireless network relay device when intercommunication between said first wireless network relay device and said second wireless network relay device via said first communications interface unit is enabled; and
said second wireless network relay device including
a second communications interface unit for communicating with said first wireless network relay device via said first communications interface unit,
a first wireless communications setup information receiving unit for receiving the first wireless communications setup information via said second communications interface unit; and
a first wireless communications unit for using the first wireless communications setup information received via said second communications interface unit to execute wireless communications with the client.

2. The wireless network system according to claim 1, wherein:
said first wireless communications setup information transmission unit, on receiving from said second wireless network relay device a request for transmission of the first wireless communications setup information, transmits the first wireless communications setup information to said second wireless network relay device; and
said second wireless network relay device further includes a request transmission unit for transmitting the transmission request to said first wireless network relay device when intercommunication between said first wireless network relay device and said second wireless network relay device via said second communications interface unit is enabled.

3. The wireless network system according to claim 1, wherein:
the second wireless network relay device further includes
a storage unit pre-storing second wireless communications setup information, and
an add-in storage control unit for storing the received first wireless communications setup information in said storage unit by adding said information to the second wireless communications setup information; and
said first wireless communications unit uses the first wireless communications setup information as stored in said storage unit to execute wireless communications with the client, and uses the second wireless communications setup information as pre-stored in said storage unit to execute wireless communications with another client different from said client.

4. The wireless network system according to claim 1, wherein:
said second wireless network relay device further includes
a storage unit pre-storing second wireless communications setup information, and
an overwrite/storage control unit for storing the received first wireless communications setup information in said storage unit by overwriting said information onto the second wireless communications setup information therein; and
said first wireless communications unit uses the first wireless communications setup information stored in said storage unit to execute wireless communications with the client.

5. The wireless network system according to claim 4, wherein at least one of either said first wireless network relay device or said second wireless network relay device includes an overwrite-store instruction input user interface for inputting an instruction to store the first wireless communications setup information in said storage unit by overwriting said information onto the second wireless communications setup information therein.

6. The wireless network system according to claim 1, wherein when said first communications interface unit and said second communications interface unit are communication-enabled by being physically in contact with each other.

7. The wireless network system according to claim 1, wherein:
said first wireless network relay device further includes
a second wireless communications unit for executing wireless communications with the client, and
a wireless communications control unit for controlling said second wireless communications unit; and
said wireless communications control unit in response to transmission of the first wireless communications setup information halts operation of said second wireless communications unit.

8. The wireless network system according to claim 1, wherein:
said first wireless network relay device further includes a distance determination unit for determining whether inter-device separation between said first wireless network relay device and said second wireless network relay device is a predetermined distance; and
said first wireless communications setup information transmission unit transmits the first wireless communications setup information to said second wireless network relay device when the inter-device separation is the predetermined distance.

9. The wireless network system according to claim 2, wherein:
said second wireless network relay device further includes a distance determination unit for determining whether inter-device separation between said first wireless network relay device and said second wireless network relay device is a predetermined distance; and
said request transmission unit transmits a transmission request to said first wireless network relay device when the inter-device separation is the predetermined distance.

10. The wireless network system according to claim 1, wherein the wireless communications setup information comprises any of a service set identifier, security class information, or a security key.

11. The wireless network system according to claim 1, wherein:
said first wireless network relay device is a mobile wireless local-area-network access point; and
said second wireless network relay device is a stationary router device.

12. A wireless network relay device preconfigured with wireless communications setup information used in wireless communications with a client, the wireless network relay device comprising:
a communications interface unit for communicating with another wireless network relay device; and
a wireless communications setup information transmission unit for transmitting the wireless communications setup information to the other wireless network relay device when intercommunication between said wireless network relay device and the other wireless network relay device is enabled.

13. The wireless network relay device according to claim 12, wherein said information transmission unit, on receiving from the other wireless network relay device a request for transmission of the wireless communications setup information, transmits the wireless communications setup information to the other wireless network relay device.

14. A wireless network relay device comprising:
a communications interface unit for communicating with another wireless network relay device preconfigured with wireless communications setup information used in wireless communications with a client;
a wireless communications setup information reception unit for receiving the wireless communications setup information via said communications interface unit; and
a wireless communications unit for using wireless communications setup information received from the other wireless network relay device via said communications interface unit to execute wireless communications with the client.

15. The wireless network relay device according to claim 14, further comprising a request transmission unit for transmitting to the other wireless network relay device a request for transmission of the wireless communications setup information when intercommunication between the other wireless network relay device and said wireless network relay device is enabled.

16. A method of controlling a wireless network system constituted by a first wireless network relay device preconfigured with first wireless communications setup information used in wireless communications with a client, and by a second wireless network relay device, the wireless network control method comprising:
(a) a step, in the first wireless network relay device, of transmitting the first wireless communications setup information to the second wireless network relay device when the first wireless network relay device and the second wireless network relay device are communication-enabled; and
(b) a step, in the second wireless network relay device, of using wireless communications setup information received from the first wireless network relay device to communicate wirelessly with the client.

17. A computer-readable non-volatile recording medium on which is recorded a program for controlling a wireless network relay device preconfigured with wireless communications setup information used in wireless communications with a client, the program for causing the wireless network relay device to realize functions of:
determining whether intercommunication between the wireless network relay device and another wireless network relay device via a communication interface is enabled; and
when intercommunication between said wireless network relay device and another wireless network relay device is enabled, of transmitting the wireless communications setup information to the other wireless network relay device.

18. A computer-readable non-volatile recording medium on which is recorded a program for controlling a wireless network relay device, the program for causing the wireless network relay device to realize:
a function of receiving wireless communications setup information from another wireless network relay device, preconfigured with the wireless communications setup information used in wireless communications with a client; and
a function of using the received wireless communications setup information to execute wireless communications with the client.

19. A portable access point physically connectable to a gateway, the access point adapted to operate in a wireless-network suspended mode in which the access point is physically connected to a gateway, and a wireless-network operational mode in which the access point is physically disconnected from a gateway, the portable access point comprising:
a data storage device storing access-point-identifying wireless communications setup information, for establishing wireless communication with a network node;
connection monitoring means for detecting whether the portable access point is connected to a gateway; and
setup information transmission/transfer control means, responsive to said connection monitoring means when said connection monitoring means detects that the portable access point is connected to a gateway, for transmitting a gateway probe request to the gateway and, conditional upon receiving a response to the probe request from the gateway, transferring from said storage the access-point-identifying wireless communications setup information as an update request to the gateway.

20. A gateway to which a portable access point is physically connectable, the gateway comprising:
a data storage device storing gateway-identifying wireless communications setup information, for establishing communication with a network node;
setup information transmission control means for conditionally transmitting the gateway-identifying wireless communications setup information to a network node; and
setup-information updating means for
checking for reception by the gateway of a probe request from a portable access point physically connected to the gateway,
transmitting a probe-request response identifying the gateway to the portable access point,
receiving access-point-identifying wireless communications setup information as an update request from the responded-to portable access point,
updating the gateway-identifying wireless communications setup information in said storage device with the received access-point-identifying wireless communications setup information, and
configuring said setup information transmission control means with the updated gateway-identifying wireless communications setup information.

21. A wireless network system comprising:
a portable access point physically connectable to a gateway, the access point adapted to operate in a wireless-network suspended mode in which the access point is physically connected to a gateway, and a wireless-network operational mode in which the access point is physically disconnected from a gateway, the portable access point including
a data storage device storing access-point-identifying wireless communications setup information, for establishing wireless communication with a network node,
connection monitoring means for detecting whether the portable access point is connected to a gateway, and
setup information transmission/transfer control means, responsive to said connection monitoring means when said connection monitoring means detects that the portable access point is connected to a gateway, for transmitting a gateway probe request to the gateway and, conditional upon receiving a response to the probe request from the gateway, transferring from said storage the access-point-identifying wireless communications setup information as an update request to the gateway; and
a gateway to which said portable access point is physically connectable, the gateway including
a data storage device storing gateway-identifying wireless communications setup information, for establishing communication with a network node,
setup information transmission control means for conditionally transmitting the gateway-identifying wireless communications setup information to a network node, and
setup-information updating means for
checking for reception by the gateway of a probe request from a portable access point physically connected to the gateway,
transmitting a probe-request response identifying the gateway to the portable access point,
receiving access-point-identifying wireless communications setup information as an update request from the responded-to portable access point,
updating the gateway-identifying wireless communications setup information in said storage device with the received access-point-identifying wireless communications setup information, and
configuring said setup information transmission control means with the updated gateway-identifying wireless communications setup information.

22. A wireless network system as set forth in claim 21, wherein said portable access point is connectable to said gateway by plugging into the gateway.
